(19) United States
(12) Patent Application Publication
(10) Pub. No.: US 2026/0297263 A1
(43) Pub. Date: Oct. 1, 2026

(54) 3D PRINTING OF CARBONACEOUS STRUCTURES FROM WATER

(71) Applicant: ARIZONA BOARD OF REGENTS ON BEHALF OF ARIZONA STATE UNIVERSITY, Scottsdale, AZ (US)

(72) Inventors: Cody WEYHRICH, Phoenix, AZ (US); Timothy LONG, Phoenix, AZ (US)

(21) Appl. No.: 19/478,183

(22) PCT Filed: Apr. 26, 2024
(86) PCT No.: PCT/US2024/026498

§ 371 Date: Oct. 23, 2025

Related U.S. Application Data
(60) Provisional application No. 63/462,470, filed on Apr. 27, 2023.

(51) Int. Cl. C08G 73/12; C08G 73/10

(52) U.S. Cl. CPC C08G 73/127; C08G 73/1071

(57) ABSTRACT

The subject matter described herein relates to polyimide compositions, methods of use, and materials thereof.

The application claims priority from U.S. Provisional Application No. 63/462,470 filed on Apr. 27, 2023, the entire contents of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention relates to polyimide compositions, methods of use, and materials thereof.

### BACKGROUND OF THE INVENTION

Graphene is comprised of sp2 hybridized carbon atoms in a single layer. Reports of printable carbon precursor macromolecules employ organic solvents to solubilize high carbon content macromolecules, which are hydrophobic and thus, are not water soluble.

### SUMMARY OF THE INVENTION

Aspects of the invention are drawn towards a polymer comprising an aromatic poly(amic acid) mainchain of the formula:

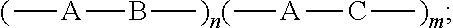

wherein A is an amic acid; B is an aromatic diamine comprising at least one anionic moiety;
and C is an aromatic diamine. In embodiments, the amic acid is

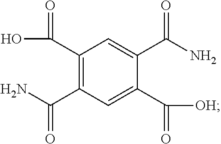 [SMILES: NC(=O)c1cc(C(=O)O)c(C(N)=O)cc1C(=O)O]

wherein the aromatic diamine comprising at least one anionic moiety can be selected from, but is not limited to, the group consisting of:

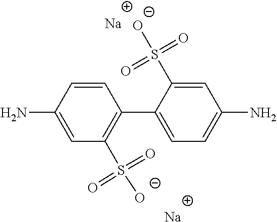 [SMILES: [Na+] ; Nc1ccc(-c2ccc(N)cc2S(=O)(=O)[O-])c(S(=O)(=O)[O-])c1 ; [Na+]]

biphenyl disulfonic acid sodium salt (BDSA-Na) or a derivative thereof;

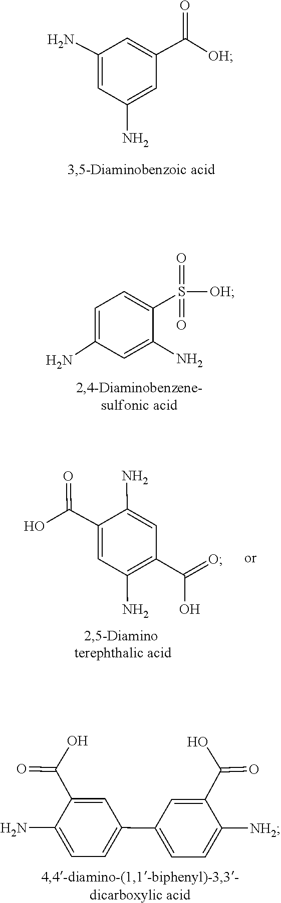 [SMILES: Nc1cc(N)cc(C(=O)O)c1 ; Nc1ccc(S(=O)(=O)O)c(N)c1 ; Nc1cc(C(=O)O)c(N)cc1C(=O)O ; Nc1ccc(-c2ccc(N)c(C(=O)O)c2)cc1C(=O)O]

and
   wherein the aromatic diamine is:

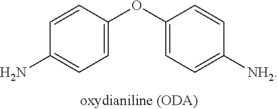 [SMILES: Nc1ccc(Oc2ccc(N)cc2)cc1]

In embodiments, the polymer is:

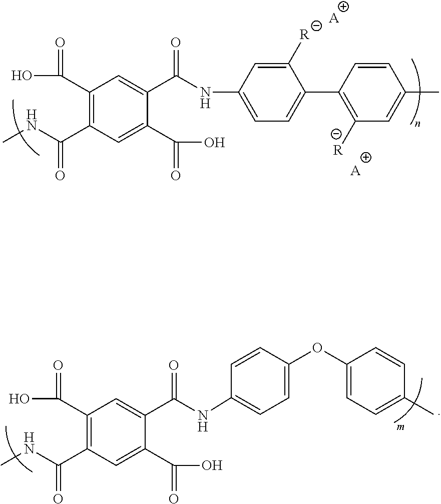

wherein R is selected from the group consisting of a sulfonate, a carboxylate, or a phosphinate; A is selected from the group consisting of Na⁺, K⁺, ammonium, or Cs⁺; and n+m=1. In embodiments, the polymer is:

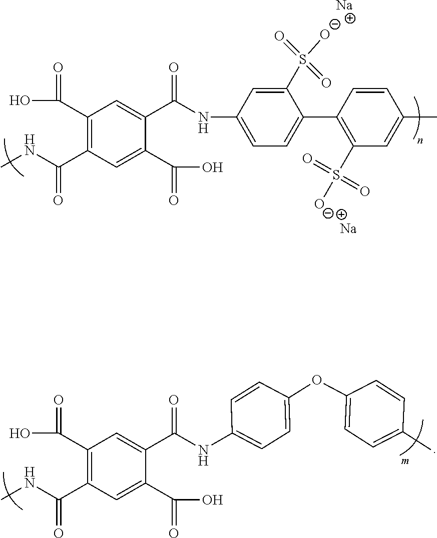

In embodiments, n is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

Aspects of the invention are drawn towards a poly(amic acid) salt comprising an aromatic poly(amic acid) mainchain, wherein the poly(amic acid) salt further comprises an anionic moiety, and wherein an amic acid of the poly(amic acid) mainchain is ionically bound to a basic agent of the following formula:

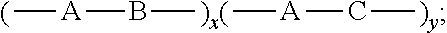

wherein the amic acid is:

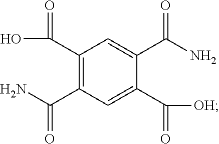 [SMILES: NC(=O)c1cc(C(=O)O)c(C(N)=O)cc1C(=O)O]

wherein the aromatic diamine comprising at least one anionic moiety is selected from the group on consisting of:

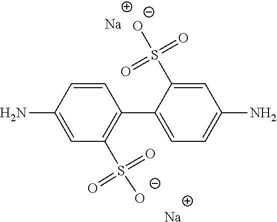 [SMILES: [Na+] ; Nc1ccc(-c2ccc(N)cc2S(=O)(=O)[O-])c(S(=O)(=O)[O-])c1 ; [Na+]]

biphenyl disulfonic acid sodium salt (BDSA-Na) or a derivative thereof;

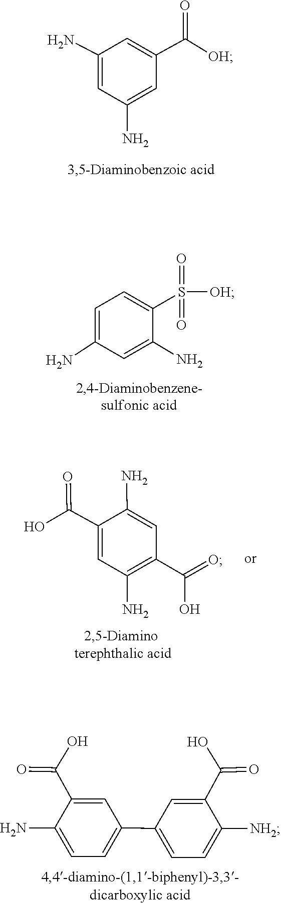 [SMILES: Nc1cc(N)cc(C(=O)O)c1 ; Nc1ccc(S(=O)(=O)O)c(N)c1 ; Nc1cc(C(=O)O)c(N)cc1C(=O)O ; Nc1ccc(-c2ccc(N)c(C(=O)O)c2)cc1C(=O)O]

and
   wherein the aromatic diamine is

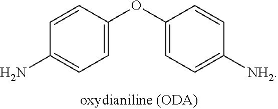 [SMILES: Nc1ccc(Oc2ccc(N)cc2)cc1]

In embodiments, the poly(amic acid) salt is

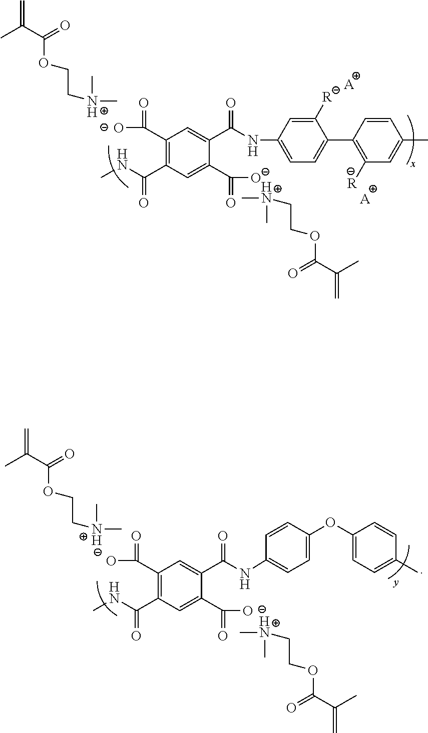

wherein R is selected from the group consisting of a sulfonate, a carboxylate, or a phosphinate; A is selected from the group consisting of Na⁺, K⁺, or Cs⁺; and x+y=1.

In embodiments, x is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0. In embodiments, the basic agent comprises a basic compound to neutralize an amic acid of the poly(amic acid) mainchain. In embodiments, the basic agent is selected from the group consisting of:

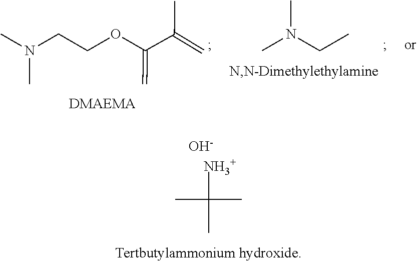

In embodiments, the poly(amic acid) salt is:

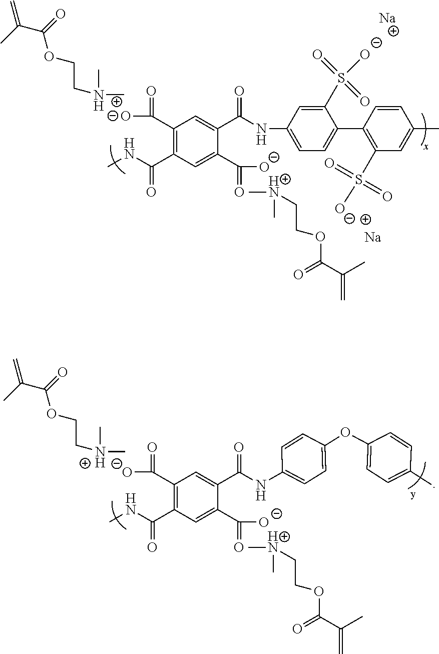

Aspects of the invention are drawn towards a polyimide produced from a poly(amic acid) salt of described herein. In embodiments, the polyimide is:

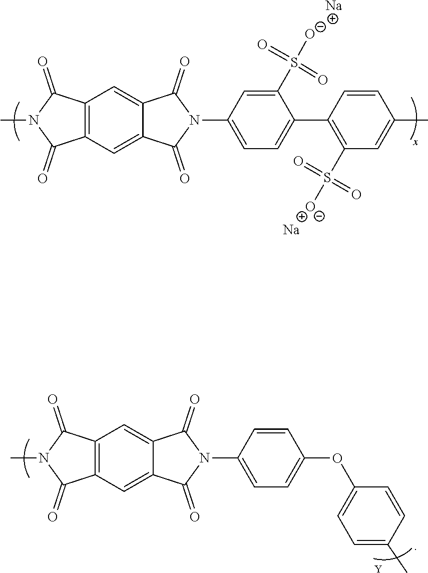

Aspects of the invention are drawn towards a method of producing a poly(amic acid) salt, the method comprising: copolymerizing an aromatic dianhydride with at least two aromatic amines, wherein at least one aromatic amine comprises at least one anionic moiety, thereby producing an aromatic poly(amic acid); and adding a basic agent to neutralize the poly(amic acid) to the poly(amic acid), thereby producing a poly(amic acid) salt. In embodiments, the aromatic dianhydride comprises pyromellitic dianhydride (PMDA). In embodiments, the aromatic amines comprises oxydianiline (ODA) or biphenyl disulfonic acid sodium salt (BDSA-Na). In embodiments, the poly(amic acid) is:

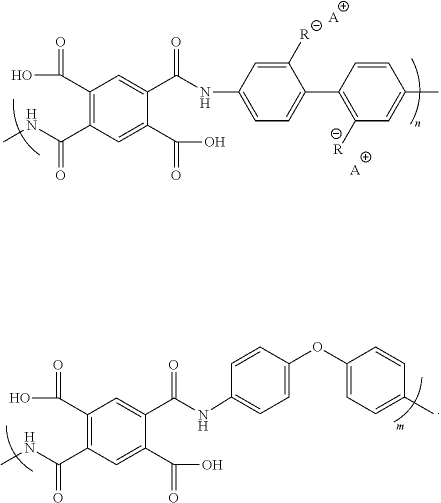

wherein R is selected from the group consisting of a sulfonate, a carboxylate, or a phosphinate; A is selected from the group consisting of Na⁺, K⁺, or Cs⁺; n+m=1; and n is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

In embodiments, the poly(amic acid) is:

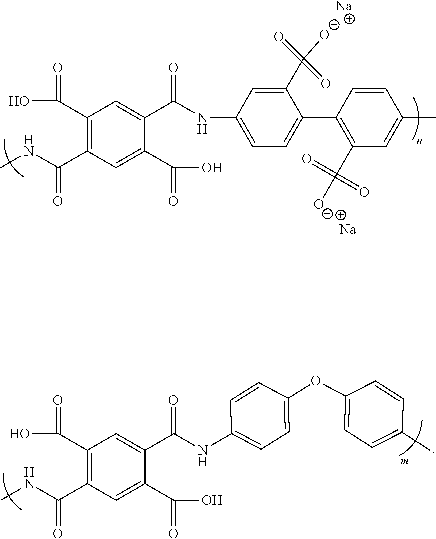

In embodiments, the basic agent comprises an amino-functionalized methacrylate. In embodiments, the basic agent is selected from the group consisting of:

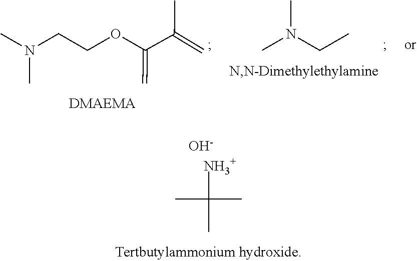

In embodiments, the poly(amic acid) salt is:

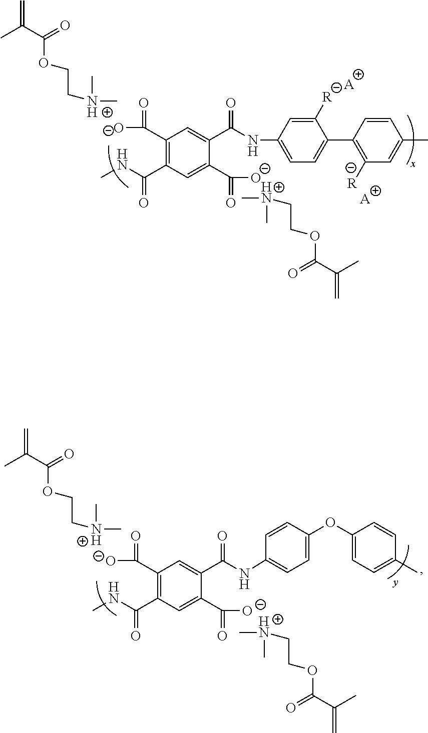

wherein R is selected from the group consisting of a sulfonate, a carboxylate, or a phosphinate; A is selected from the group consisting of Na⁺, K⁺, or Cs⁺; x+y=1; and x is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

In embodiments, the poly(amic acid) salt is:

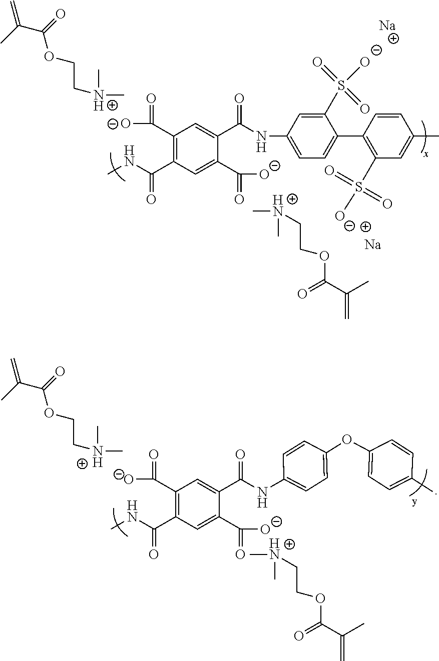

Aspects of the invention are drawn towards an ink formulation comprising a poly(amic acid) salt described herein, water, a photoinitiator, or a combination thereof. In embodiments, the formulation further comprises a viscosity modifier. In embodiments, the ink further comprises a scaffold and a surfactant. In embodiments, the poly(amic acid) salt is:

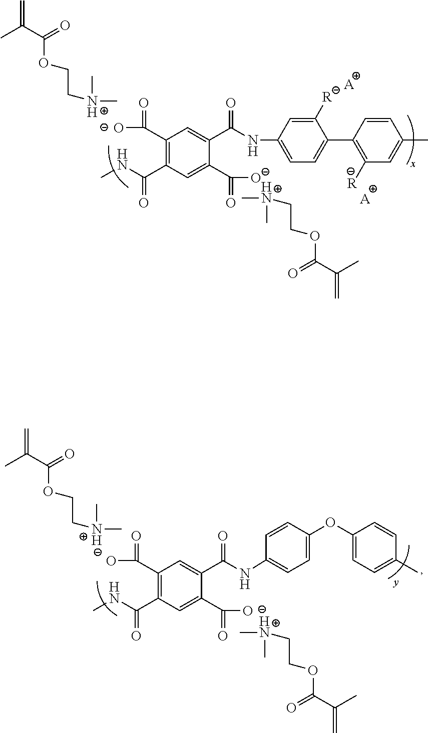

wherein R is selected from the group consisting of a sulfonate, a carboxylate, or a phosphinate; A is selected from the group consisting of Na⁺, K⁺, or Cs⁺; x+y=1; and x is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0. In embodiments, the viscosity modifier comprises polyethylene glycol diacrylate (PEGDA).

The ink formulation of claim 23, wherein the photoinitiator is selected from the group consisting of a modified bis(acyl)phosphane oxide or lithium phenyl-2,4,6 trimethylbenzoylphosphinate (LAP). In embodiments, the ink displays shear thinning behavior. In embodiments, the surfactant is sodium dodecylbenzene sulfonate.

Aspects of the invention are drawn towards a method of producing a three-dimensional object, the method comprising: depositing the ink formulation described herein on a substrate; and irradiating the deposited ink formulation with UV radiation in an amount sufficient to induce curing of the ink formulation, thereby producing a three-dimensional object. In embodiments, the method further comprises: drying the three-dimensional object in vacuo; heating the three-dimensional object to about 400°; and cooling the object to about 25° C. In embodiments, the method further comprises: subjecting the three-dimensional object to a temperature of about −24° C. overnight; submerging the three-dimensional object in an acetone/dry ice bath; and subjecting the object to imidization.

Aspects of the invention are drawn towards a three-dimensional object produced by a method described herein.

Aspects of the invention are drawn towards a method of producing a three-dimensional carbonaceous structure, the method comprising: depositing the ink formulation described herein on a substrate; irradiating the deposited ink formulation with UV radiation in an amount sufficient to induce curing of the ink formulation, thereby producing a three-dimensional object; subjecting the three-dimensional object to a temperature of about −24° C. overnight; submerging the three-dimensional object in an acetone/dry ice bath; subjecting the three-dimensional object to imidization; and subjecting the three-dimensional object to pyrolysis, thereby producing a three-dimensional carbonaceous structure.

Aspects of the disclosure are drawn towards a three-dimensional carbonaceous structure produced by the methods described herein.

Aspects of the invention are drawn towards a polyimide produced by any one of the ink formulations or methods described herein.

Other objects and advantages of this invention will become readily apparent from the ensuing description.

### BRIEF DESCRIPTION OF THE FIGURES

FIG. 1 shows an exemplary synthetic scheme of copolymerization of PMDA with ODA and BDSA-Na. This reaction yields partially sulfonated, fully aromatic poly(amic acid) s.

FIG. 2 shows an exemplary synthetic scheme and experiment results. Panel A) Synthetic scheme for the complete neutralization of pendant sPAA carboxylic acids with DMAEMA, which provides ionically bound methacrylate functionality for photo-processing. Panel B) Digital photograph of a fully neutralized sPAAS solution.

FIG. 3 shows non-limiting, exemplary dynamic light scattering of 1.5 wt. % aqueous sPAAS solution displays peak hydrodynamic radius of 15 nm and a lack of aggregation in solution.

FIG. 4 shows non-limiting, exemplary flow sweep rheology experimental results. Steady-state shear analysis displays shear thinning behavior of the sPAAS ink.

FIG. 5 shows non-limiting, exemplary photorheological measurements. The photorheological measurements showcase fast crosslinking and high hydrogel stiffness for aqueous sPAAS inks.

FIG. 6 shows non-limiting, exemplary results of a variable frequency oscillatory experiment of 25 wt. % sPAAS with 2.5 wt. % PEGDA.

FIG. 7 shows non-limiting, exemplary results of oscillatory frequency sweep. Oscillatory frequency sweep shows that sPAAS solutions exhibit solid-like (G′>G″) behavior above 64 rad/s and more liquid-like (G′<G″) behavior below 64 rad/s.

FIG. 8 shows non-limiting, exemplary digital photographs of UV-DIW printing of sPAAS ink (Panel A) and the as-printed sPAAS hydrogel (Panel B).

FIG. 9 shows non-limiting, exemplary micrographs of a printed sPAAS specimen after drying. Microscopy of external surface (Panel A) and cross-section (Panel B) indicate that these UV-DIW printed parts display less pronounced layer lines than typical DIW prints.

FIG. 10 shows non-limiting, exemplary cross-sectional scanning electron micrographs of freeze-cast imidized structure and the freeze-cast carbonaceous.

FIG. 11 shows a non-limiting, exemplary Raman spectrum of the printed porous carbon derived from the carbonization of sPAAS at 1600° C.

FIG. 12 shows non-limiting, exemplary digital photographs of sPAAS hydrogels before (Panel A) and after (Panel B) carbonization fabricated with VP

FIG. 13 shows non-limiting, exemplary digital photographs of as-printed sPAAS hydrogel (Panel A), the freeze-cast sPAAS (Panel B), and freeze-cast sPI (Panel C).

FIG. 14 shows non-limiting, exemplary digital photographs of freeze-cast imidized structure (Panel A) and the freeze-cast carbonaceous foam (Panel B) after fracturing for microscopy.

FIG. 15 shows non-limiting, exemplary cross-sectional scanning electron micrographs of freeze-cast sPAAS part (Panel A) and the freeze-cast carbonaceous foam (Panel B).

FIG. 16 shows non-limiting, exemplary synthetic methods to produce water-soluble and photocurable polyimide precursors.

FIG. 17 shows a non-limiting, exemplary graph of amplitude (strain) sweep.

FIG. 18 shows a non-limiting, exemplary graph of frequency sweep.

FIG. 19 shows non-limiting, exemplary photographs of poly(amic acid) 3D structures.

FIG. 20 shows non-limiting, exemplary photographs of a 3D printer and hydrogel precursors and a product of the hydrogel precursor.

FIG. 21 shows non-limiting, exemplary isotherms at 25° C. and 40° C.

FIG. 22 shows non-limiting, exemplary schemes of the disclosure.

FIG. 23 shows non-limiting, exemplary particle size data.

FIG. 24 shows non-limiting, exemplary TGA data.

FIG. 25 shows non-limiting, exemplary rheology data.

FIG. 26 shows non-limiting, exemplary storage moduli at varying crosslinker concentrations.

FIG. 27 shows non-limiting, exemplary images applications of the disclosure.

### DETAILED DESCRIPTION OF THE INVENTION

Detailed descriptions of one or more embodiments are provided herein. However, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification can refer to “one,” but it is also consistent with “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably. Specifically, each of the terms used herein is consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” can refer to a process that includes at least steps a, b and c. Wherever the terms “a” or “an” are used, “one or more” is understood, unless such interpretation is nonsensical in context.

As used herein, the term “about” can refer to approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

As used herein, the term “substantially the same” or “substantially” can refer to variability typical for a particular method is taken into account.

The terms “sufficient” and “effective”, as used interchangeably herein, can refer to an amount (e.g., mass, volume, dosage, concentration, and/or time period) needed to achieve one or more desired result(s).

Before explaining at least one embodiment of the disclosure in detail, the disclosure is not necessarily limited in its application to the details set forth in the following description or exemplified by the examples. The disclosure is capable of other embodiments or of being practiced or carried out in various ways. Other compositions, compounds, methods, features, and advantages of the present disclosure will be or become apparent to one having ordinary skill in the art upon examination of the following drawings, detailed description, and examples. All such additional compositions, compounds, methods, features, and advantages can be included within this description, and be within the scope of the present disclosure.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some embodiments, a straight chain or branched chain alkyl has 30 or fewer carbon atoms in its backbone (e.g., C1-C30 for straight chains, C3-C30 for branched chains), 20 or fewer, 12 or fewer, or 7 or fewer. Likewise, in some embodiments cycloalkyls have from 3-10 carbon atoms in their ring structure, e.g., have 5, 6 or 7 carbons in the ring structure. The term “alkyl” (or “lower alkyl”) as used throughout the specification, examples, and claims can include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein can refer to an alkyl group, as defined above, but having from one to ten carbons, or from one to six carbon atoms in its backbone structure. Likewise, “lower alkenyl” and “lower alkynyl” have similar chain lengths. In some embodiments, alkyl groups are lower alkyls. In some embodiments, a substituent designated herein as alkyl is a lower alkyl.

Those skilled in the art understand that the moieties substituted on the hydrocarbon chain can themselves be substituted, if appropriate. For instance, the substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF3, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined above for alkyl groups.

The term “alkylthio” refers to an alkyl group, as defined above, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined above for alkyl groups.

The terms “alkenyl” and “alkynyl”, refer to unsaturated aliphatic groups analogous in length and possible substitution to the alkyls described above, but that contain at least one double or triple bond respectively.

The terms “alkoxyl” or “alkoxy” as used herein refers to an alkyl group, as defined above, having an oxygen radical attached thereto. Representative alkoxyl groups include methoxy, ethoxy, propyloxy, and tert-butoxy. An “ether,” for example, can be two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined below. The alkoxy and aroxy groups can be substituted as described above for alkyl.

The terms “amine” and “amino” are art-recognized and refer to both unsubstituted and substituted amines, e.g., a moiety that can be represented by the general formula:

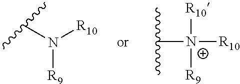

wherein R₉, R₁₀, and R_{10′} each independently represent a hydrogen, an alkyl, an alkenyl, —(CH₂)ₘ— Rs or R₉ and R₁₀ taken together with the N atom to which they are attached complete a heterocycle having from 4 to 8 atoms in the ring structure; Rs represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R_{10′}) each independently represent a hydrogen, an alkyl or cycloalkyl, an alkenyl or cycloalkenyl, or alkynyl. Thus, the term “alkylamine” as used herein can refer to an amine group, as defined above, having a substituted (as described above for alkyl) or unsubstituted alkyl attached thereto, i.e., at least one of R₉ and R₁₀ is an alkyl group.

As used herein, the term “imide” can refer to —C(O)NR′R″, wherein R′ and R″ are each independently hydrogen, or a substituted or unsubstituted alkyl, cycloalkyl, alkenyl, alkynyl, aryl aralkyl, heterocyclyl or heterocyclylalkyl group as defined herein.

As used herein, the term “halogen” can refer to —F, —Cl, —Br or —I; the term “sulfhydryl” can refer to —SH; the term “hydroxyl” can refer to —OH; and the term “sulfonyl” can refer to —SO₂—.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, for example 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C3-C20 cyclic, substituted C3-C20 cyclic, heterocyclic, substituted heterocyclic, amino acid, peptide, and polypeptide groups.

Heteroatoms such as nitrogen can have hydrogen substituents and/or any permissible substituents of organic compounds described herein which satisfy the valences of the heteroatoms. “Substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen can have hydrogen substituents and/or any permissible substituents of organic compounds described herein which satisfy the valencies of the heteroatoms.

In various aspects, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

The term “copolymer” as used herein, can refer to a single polymeric material that is comprised of two or more different monomers. The copolymer can be of any form, such as random, block, graft, etc. The copolymers can have any end-group, including capped or acid end groups.

Described herein are poly(amic acids) with pendant anionic functionalities to poly(amic acids, and which upon neutralization, form water-soluble all-aromatic polyimide precursors or partially soluble aromatic polyimide precursors dispersions. In embodiments, the ink formulations described herein can be soluble in water or aqueous solution.

As used herein, the term “dispersion” can refer to a system in which a substance is distributed in a continuous phase. As used herein, the term “continuous phase” can refer to a liquid phase in which the polymerization components (i.e., polymer precursors, catalyst, acid, etc.) are dissolved, suspended and/or emulsified. Continuous phases may be either hydrophilic or hydrophobic and have varying viscosities. Mixtures of two or more different continuous phases are also contemplated. Any number of different liquids (e.g., solvents) may be employed within the context of the invention as described in more detail herein. For example, the substance distributed in a continuous phase can be a polymer or polymer precursor described herein. For example, the continuous phase can comprise an aqueous phase, an organic phase, or a combination thereof.

As used herein, the term “polymer precursor” can refer to a compound used in the synthesis or preparation of a polymer. For example, polymer precursors can comprise monomers, dimers, and oligomers.

Aspects of the invention are drawn towards a polymer comprising an aromatic poly(amic acid) mainchain, wherein the polymer further comprises an anionic moiety. As used herein, the term “poly(amic) acid” can refer to a polymer containing both a carboxylic acid and an amide functional group in the backbone.

For example, the polymer can be a polymer of the following formula:

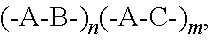

wherein A is an amic acid formed from a dianhydride;
B is an aromatic diamine comprising at least one anionic moiety; and
C is an aromatic diamine.

In embodiments, the dianhydride can be, but is not limited to:

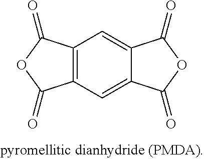 [SMILES: O=c1oc(=O)c2cc3c(=O)oc(=O)c3cc12]

In embodiments, the amic acid can be, but is not limited to:

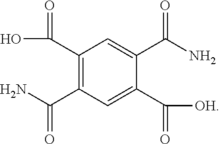 [SMILES: NC(=O)c1cc(C(=O)O)c(C(N)=O)cc1C(=O)O]

In embodiments, the aromatic diamine comprising at least one anionic moiety can be selected from, but is not limited to, the group consisting of:

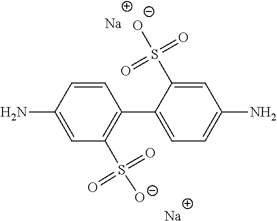 [SMILES: [Na+] ; Nc1ccc(-c2ccc(N)cc2S(=O)(=O)[O-])c(S(=O)(=O)[O-])c1 ; [Na+]]

biphenyl disulfonic acid sodium salt (BDSA-Na) or a derivative thereof;

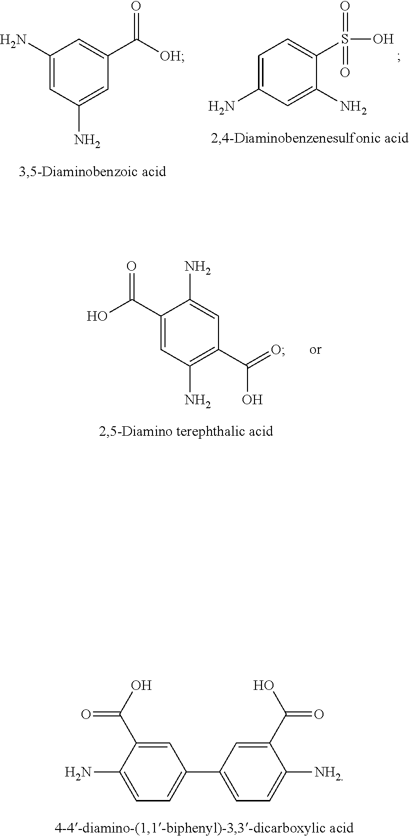 [SMILES: Nc1cc(N)cc(C(=O)O)c1 ; Nc1ccc(S(=O)(=O)O)c(N)c1 ; Nc1cc(C(=O)O)c(N)cc1C(=O)O ; Nc1ccc(-c2ccc(N)c(C(=O)O)c2)cc1C(=O)O]

In embodiments, the aromatic diamine can be, but is not limited to:

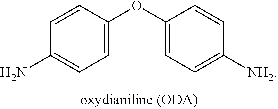 [SMILES: Nc1ccc(Oc2ccc(N)cc2)cc1]

In embodiments, the polymer is:

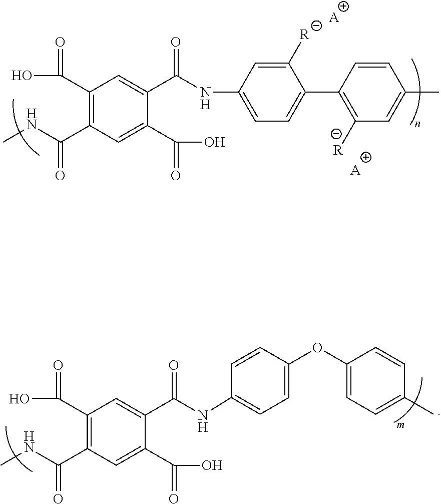

In embodiments, R is selected from the group consisting of a sulfonate, a carboxylate, or a phosphinate. In embodiments A is any divalent cation, any monovalent cation, or a non-metal cation. In embodiments, A is selected from the group consisting of Na⁺, K⁺, Li⁺, Ca⁺, ammonium, or Cs⁺. For example, the ammonium is tetraethyl ammonium.

In embodiments, n+m=1. For example, “n” is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

In embodiments, “m” is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

In embodiments, the polymer is:

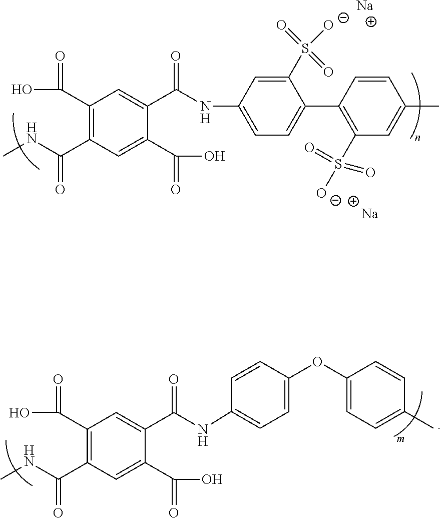

In embodiments, the polymers or polymer precursors described herein can have a number average molecular weight (Mn) less than about 8000 g/mol to greater than about 100,000 g/mol. For example, the Mn can be about 8000 g/mol, about 10,000 g/mol, about 12,500 g/mol, about 15,000 g/mol, about 17,500 g/mol, about 20,000 g/mol, about 22,500 g/mol, about 25,000 g/mol, about 27,500 g/mol, about 30,000 g/mol, about 32,500 g/mol, about 35,000 g/mol, about 37,500 g/mol, about 40,000 g/mol, about 42,500 g/mol, about 45,000 g/mol, about 47,500 g/mol, about 50,000 g/mol, about 55,000 g/mol, about 60,000 g/mol, about 65,000 g/mol, about 70,000 g/mol, about 75,000 g/mol, about 80,000 g/mol, about 85,000 g/mol, about 90,000 g/mol, about 95,000 g/mol, about 100,000 g/mol, about 110,000 g/mol, about 120,000 g/mol, about 150,000 g/mol, or greater than about 150,000 g/mol.

In embodiments, neutralizing the poly(amic) acids can produce polyimide precursors. As used herein, the term “polyimide” can refer to a polymer containing imide groups. In embodiments, the polyimide precursors can be water soluble. As used herein, the term “water soluble” can refer to a composition that is soluble in aqueous fluid.

In embodiments, the polyimide precursor can be aromatic. As used herein, the term “aromatic” can refer to a compound that has a monocyclic, conjugated system containing (4n+2) pi electrons.

In embodiments, the amic acid of the poly(amic acid) mainchain can be ionically bound to a basic agent. For example, the basic agent can refer to a basic compound. In embodiments, the basic agent comprises a basic compound to neutralize an amic acid of the poly(amic acid) mainchain.

For example, the basic agent can be:

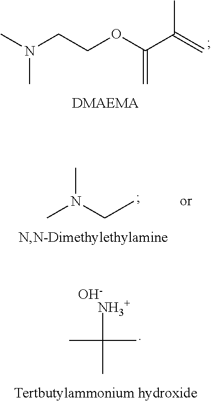

For example, the polymer can be a polymer of the following formula:

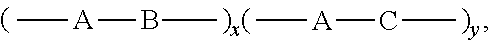

wherein A is an amic acid of the poly(amic acid) mainchain is ionically bound to a basic agent;
B is an aromatic diamine comprising at least one anionic moiety; and
C is an aromatic diamine.

In embodiments, the amic acid can be

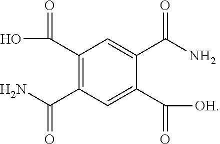 [SMILES: NC(=O)c1cc(C(=O)O)c(C(N)=O)cc1C(=O)O]

In embodiments, the aromatic diamine comprising at least one anionic moiety can be selected from, but is not limited to, the group consisting of:

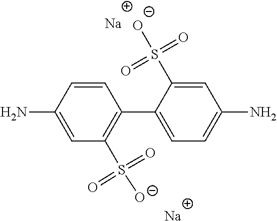 [SMILES: [Na+] ; Nc1ccc(-c2ccc(N)cc2S(=O)(=O)[O-])c(S(=O)(=O)[O-])c1 ; [Na+]]

biphenyl disulfonic acid sodium salt (BDSA-Na) or a derivative thereof;

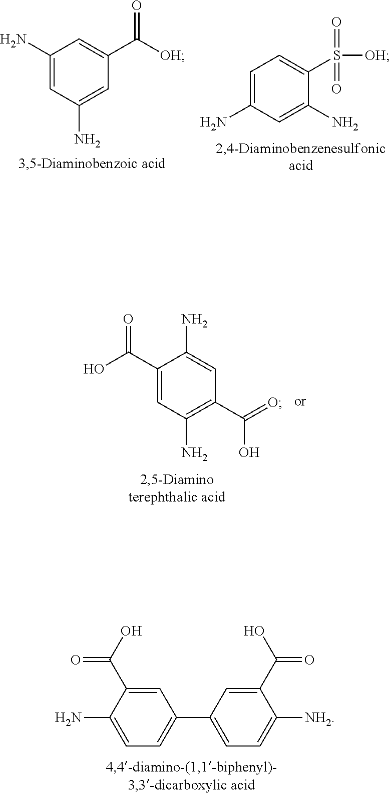 [SMILES: Nc1cc(N)cc(C(=O)O)c1 ; Nc1ccc(S(=O)(=O)O)c(N)c1 ; Nc1cc(C(=O)O)c(N)cc1C(=O)O ; "or" ; Nc1ccc(-c2ccc(N)c(C(=O)O)c2)cc1C(=O)O]

In embodiments, the aromatic diamine can be:

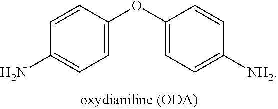 [SMILES: Nc1ccc(Oc2ccc(N)cc2)cc1]

In embodiments, the basic agent is an amino-functionalized methacrylate. For example, the amino-functionalized methacrylate is 2-(dimethylamino)ethyl methacrylate (DMAEMA).

Aspects of the disclosure are drawn towards a poly(amic acid) salt of the following structure:

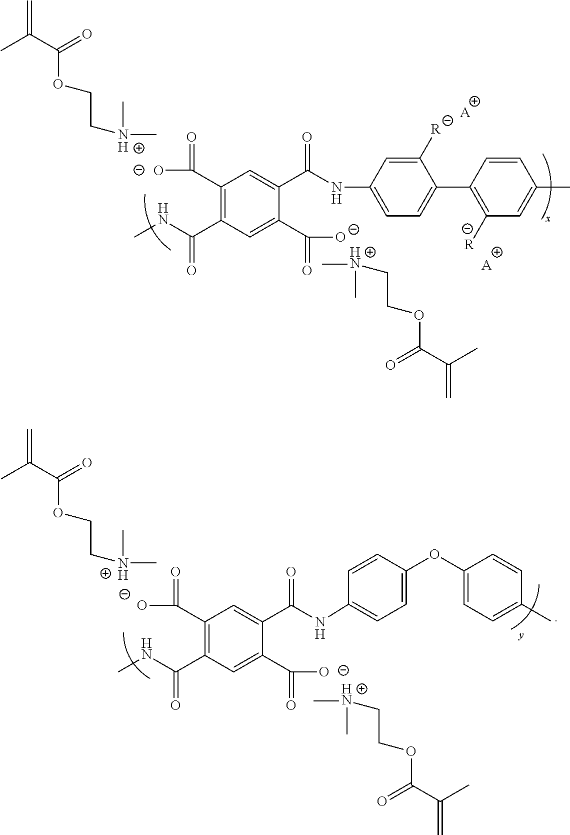

In embodiments, R is selected from the group consisting of a sulfonate, a carboxylate, or a phosphinate. In embodiments A is any divalent cation, any monovalent cation, or a non-metal cation. In embodiments, A is selected from the group consisting of Na⁺, K⁺, Li⁺, Ca⁺, ammonium, or Cs⁺. For example, the ammonium is tetraethyl ammonium.

As used herein, the terms “poly(amic) salt” and “polyimide precursor” can be used interchangeably.

The poly(amic acid) salt of claim 6, wherein the poly(amic acid) salt is:

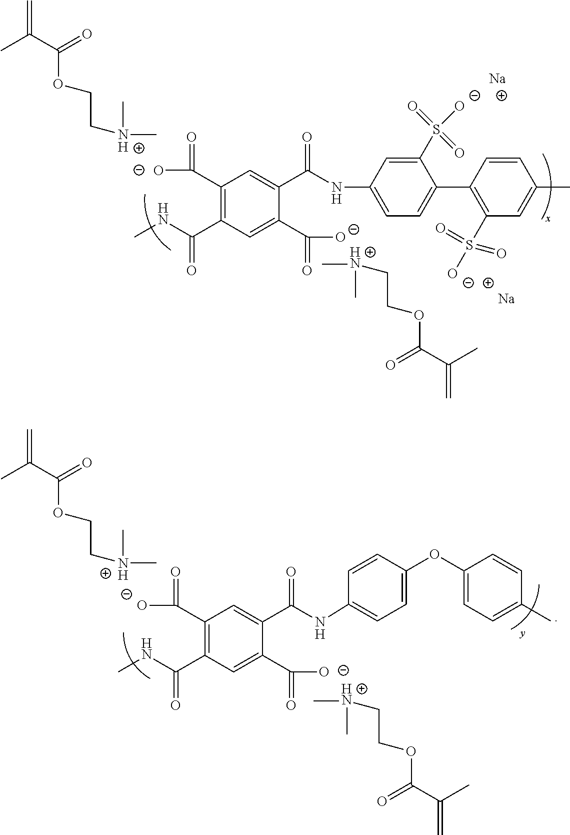

In embodiments, the x+y=1. For example, x can be selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

In embodiments, y can be selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

For example, x can correspond to the following mol % values:

| X value | BDSA-Na mol % | ODA mol % |
|---|---|---|
| 0.05 | 5 mol % | 95 mol % |
| 0.10 | 10 mol % | 90 mol % |
| 0.15 | 15 mol % | 85 mol % |
| 0.20 | 20 mol % | 80 mol % |
| 0.25 | 25 mol % | 75 mol % |
| 0.30 | 30 mol % | 70 mol % |
| 0.35 | 35 mol % | 65 mol % |

Aspects of the disclosure are drawn towards a method of producing a poly(amic acid) salt comprising copolymerizing an aromatic dianhydride with at least two aromatic amines, wherein at least one aromatic amine comprises at least one anionic moiety, thereby producing an aromatic poly(amic acid); and adding a basic agent to neutralize the poly(amic acid) to the poly(amic acid), thereby producing a poly(amic acid) salt. In embodiments, the aromatic dianhydride can be pyromellitic dianhydride (PMDA). In embodiments, the aromatic amines can be oxydianiline (ODA), biphenyl disulfonic acid sodium salt (BDSA-Na), 3,5-Diaminobenzoic acid, 2,4-Diaminobenzenesulfonic acid, 2,5-Diamino terephthalic acid, 4,4′-diamino-(1,1′-biphenyl)-3,3′-dicarboxylic acid, or derivative thereof.

For example, the diamines can be selected from, but are not limited to:

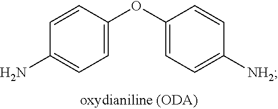 [SMILES: Nc1ccc(Oc2ccc(N)cc2)cc1]

biphenyl disulfonic acid sodium salt (BDSA-Na) or a derivative thereof

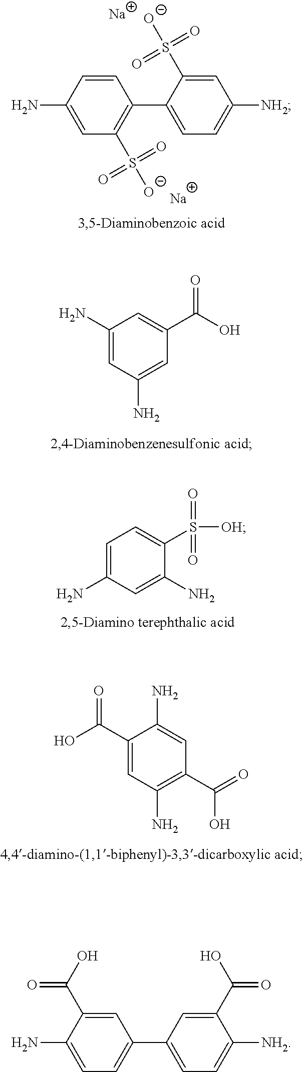

For example, the poly(amic acid) is:

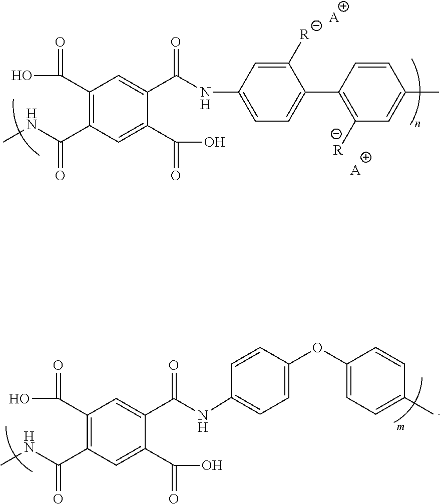

In embodiments, R is selected from the group consisting of a sulfonate, a carboxylate, or a phosphinate. In embodiments, A is selected from the group consisting of Na⁺, K⁺, or Cs⁺.

In embodiments, n+m=1. For example, n is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

In embodiments, the poly(amic acid) is:

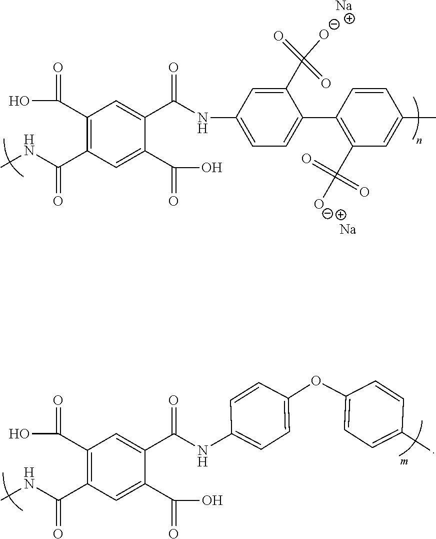

In embodiments, the basic agent can be an amino-functionalized methacrylate. For example, the amino-functionalized methacrylate can be 2-(dimethylamino)ethyl methacrylate (DMAEMA).

For example, the poly(amic acid) salt is:

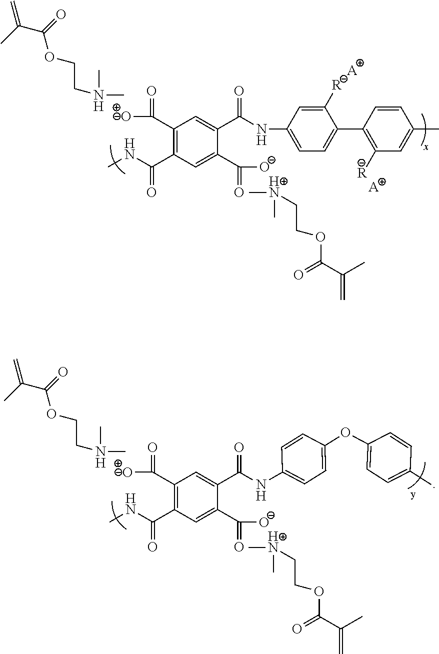

In embodiments, R is selected from the group consisting of a sulfonate, a carboxylate, or a phosphinate. In embodiments, A is selected from the group consisting of Na⁺, K⁺, or Cs⁺. In embodiments, x+y=1. For example, x is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

For example, the poly(amic acid) salt is:

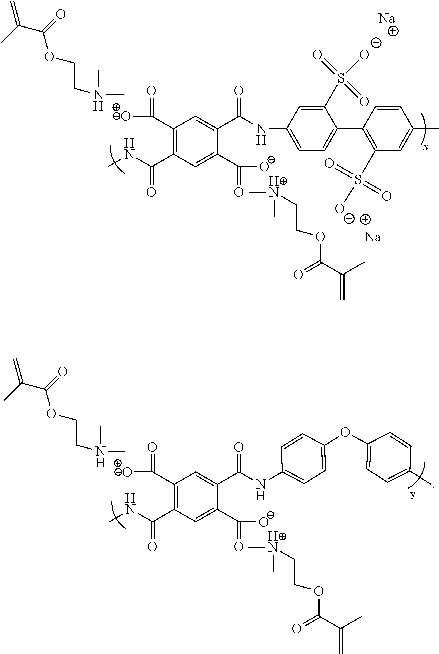

Aspects of the disclosure are drawn toward an ink formulation comprising the poly(amic acid) salt described herein, water, a viscosity modifier, a photoinitiator, or a combination thereof.

For example, the viscosity modifier comprises polyethylene glycol diacrylate (PEGDA) or any liquid diacrylate. In embodiments, the viscosity modifier can be present in about 0.1 wt. % to 10 wt. % of the total formulation weight. For example, the scaffold can be present in about less than 0.1 wt. %, about 0.1 wt. %, 0.25 wt. %, about 0.5 wt. %, about 0.75 wt. %, about 1.0 wt. %, about 1.25 wt. %, about 1.5 wt. %, about 1.75 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10.0 wt. %, or greater than about 10.0 wt. %.

In embodiments, the ink formulation can comprise less than about 5 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or greater than about 95 wt % dissolved solids in an aqueous solvent.

For example, the photoinitiator can be any water soluble photoinitiator known in the art. For example, the photoinitiator is selected from the group consisting of a modified bis(acyl)phosphane oxide or lithium phenyl-2,4,6-trimethylbenzoylphosphinate (LAP). In embodiments, the photoinitiator can be present in about 0.1 wt. % o about 5 wt. %. For example, the photoinitiator can be present in about less than 0.1 wt. %, about 0.1 wt. %, 0.25 wt. %, about 0.5 wt. %, about 0.75 wt. %, about 1.0 wt. %, about 1.25 wt. %, about 1.5 wt. %, about 1.75 wt. %, about 2.0 wt. %, about 2.5 wt. %, about 3.0 wt. %, about 3.5 wt. %, about 4.0 wt. %, about 4.5 wt. %, about 5.0 wt. %, or greater than about 5.0 wt. %.

In embodiments, the surfactant can be any surfactant know in the art. For example, the surfactant is selected from the group consisting of sodium dodecylbenzene sulfonate, caprylocaproyl polyoxyl-8 glycerides, macrogolglycerol ricinoleate, any other hydrophilic surfactant with Hydrophile-Lipophile Balance (HLB) value between about 9 to about 18, or combinations thereof. For example, the surfactant has an HLB value greater than about 9. In embodiments, the surfactant can be present in about 0.1 wt. % to about 2.0 wt. %. For example, the surfactant can be present in about less than 0.1 wt. %, about 0.1 wt. %, 0.25 wt. %, about 0.5 wt. %, about 0.75 wt. %, about 1.0 wt. %, about 1.25 wt. %, about 1.5 wt. %, about 1.75 wt. %, about 2.0 wt. %, about 2.5 wt. %, about 3.0 wt. %, about 3.5 wt. %, about 4.0 wt. %, about 4.5 wt. %, about 5.0 wt. %, or greater than about 5.0 wt. %.

In embodiments, the ink displays shear thinning behavior.

In embodiments the compositions described herein can fully water soluble or partially water soluble. For example, varying the percentage of ionic group incorporation into the polymer can affect water solubility. In some embodiments, the ink formulation further comprises a scaffold and a surfactant, forming a dispersion. In embodiments, the scaffold can comprise any suitable scaffold known in the art. For example, the scaffold can be PEGDa 575, N-Vinylpyrrolidone, Ethyleneglycol dimethacrylate, or a combination thereof.

For example, N-Vinylpyrrolidone can be

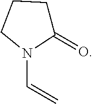

For example, Ethyleneglycol dimethacrylate can be:

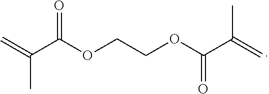

In embodiments, the scaffold can be present in about 0.1 wt. % to 20 wt. % of the total dispersion weight. For example, the scaffold can be present in about less than 0.1 wt. %, about 0.1 wt. %, 0.25 wt. %, about 0.5 wt. %, about 0.75 wt. %, about 1.0 wt. %, about 1.25 wt. %, about 1.5 wt. %, about 1.75 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10.0 wt. %, about 11.0 wt. %, about 12.0 wt. %, about 13.0 wt. %, about 14.0 wt. %, about 15.0 wt. %, about 16.0 wt. %, about 17.0 wt. %, about 18.0 wt. %, about 19.0 wt. %, about 20.0 wt. %, or greater than about 20.0 wt. %.

In some embodiments, the combination of scaffolds can comprise a combination of PEGDa 575 in about 0.1 wt. % to about 10 wt. % and NVP in about 0.1 wt. % to about 10 wt. %.

For example, the compositions described herein can comprise less than about 1 mol % ionic group, about 1 mol % ionic group, about 2.5 mol % ionic group, about 5 mol % ionic group, about 10 mol % ionic group, about 15 mol % ionic group, about 20 mol % ionic group, about 25 mol % ionic group, about 30 mol % ionic group, about 35 mol % ionic group, about 40 mol % ionic group, about 45 mol % ionic group, about 50 mol % ionic group, about 55 mol % ionic group, about 60 mol % ionic group, about 65 mol % ionic group, about 70 mol % ionic group, about 75 mol % ionic group, about 80 mol % ionic group, about 85 mol % ionic group, about 90 mol % ionic group, about 95 mol % ionic group, about 99 mol % ionic group, or about than 100 mol % ionic group.

TABLE 1
Water solubility and creasability of
sPI series of PMDA-BDSA-Na/PMDA-ODA

| BDSA-NA | Polyamic acid | Polyimide | Dry polyimide |
|---|---|---|---|
| mol % | solubility | solubility | Creasability |
| 0 | − | − | ++ |
| 25 | − | − | ++ |
| 50 | + | − | + |
| 75 | ++ | + | − |
| 100 | ++ | ++ | − |

For example, varying BDSA-Na loading varies the solubility of polyimide precursor in water. Reducing BDSA-Na loading below 50 mol % can allow water dispersibility. For example, ink formulations herein can be formulated as a soluble formulation or a dispersion.

For example, the compositions described herein can comprise less than about 1 mol % BDSA-Na, about 1 mol % BDSA-Na, about 2.5 mol % BDSA-Na, about 5 mol % BDSA-Na, about 10 mol % BDSA-Na, about 15 mol % BDSA-Na, about 20 mol % BDSA-Na, about 25 mol % BDSA-Na, about 30 mol % BDSA-Na, about 35 mol % BDSA-Na, about 40 mol % BDSA-Na, about 45 mol % BDSA-Na, about 50 mol % BDSA-Na, about 55 mol % BDSA-Na, about 60 mol % BDSA-Na, about 65 mol % BDSA-Na, about 70 mol % BDSA-Na, about 75 mol % BDSA-Na, about 80 mol % BDSA-Na, about 85 mol % BDSA-Na, about 90 mol % BDSA-Na, about 95 mol % BDSA-Na, about 99 mol % BDSA-Na, or about 100 mol % BDSA-Na.

In embodiments, mechanical stirring followed by sonication can be used. For example, an emulsifier can be used at about 10k rpm for about 10 mins followed by using a tip sonicator to disperse the particles in water. In embodiments, a surfactant is added to stabilize the dispersion along with a water soluble photoinitiator. In embodiments, the dispersion is a latex dispersion.

Further, PEGDA 575 can be added as a crosslinker to modulate the storage modulus. In embodiments, the storage modulus can comprise about 10³ to about 10⁶ Pa.

In embodiments, the crosslinker can comprise about 0 wt. % to about 20 wt. % of the ink formulation. For example, the crosslinker can be present in less than about 0.1 wt. %, about 0.1 wt. %, about 0.25 wt. %, about 0.5 wt. %, about 0.75 wt. %, about 1 wt. %, about 2.5 wt. %, about 5.0 wt. %, about 7.5 wt. %, about 10 wt. %, about 12.5 wt. %, about 15 wt. %, about 17.5 wt. %, about 20 wt. %, or greater than about 20 wt. %.

Once all components are added, the solution is sonicated for further mixing. In embodiments, dispersing polyimide in water allows potential to vary morphology and allow control over thermal and mechanical performance. Dispersing polyimide also allows pathway for porous 3D carbon structures optimal for infiltration with nanoparticles etc.

In embodiments, the poly(amic) salts can be processed to form a polyimide. For example, the processing can comprise pyrolysis or any method of imidization.

For example, the polyimide can be of following formula:

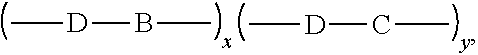

wherein A is a imide of the amic acid salts;
B is an aromatic diamine comprising at least one anionic moiety; and
C is an aromatic diamine.

In embodiments, the imide can be, but is not limited to:

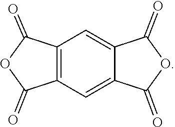 [SMILES: O=c1oc(=O)c2cc3c(=O)oc(=O)c3cc12]

In embodiments, the aromatic diamine comprising at least one anionic moiety can be selected from, but is not limited to, the group consisting of:

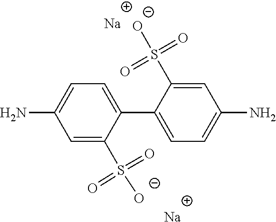 [SMILES: [Na+] ; Nc1ccc(-c2ccc(N)cc2S(=O)(=O)[O-])c(S(=O)(=O)[O-])c1 ; [Na+]]

biphenyl disulfonic acid sodium salt (BDSA-Na) or any derivative thereof;

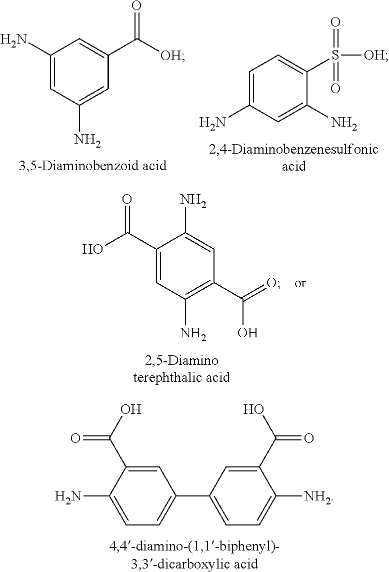 [SMILES: Nc1cc(N)cc(C(=O)O)c1 ; Nc1ccc(S(=O)(=O)O)c(N)c1 ; Nc1cc(C(=O)O)c(N)cc1C(=O)O ; Nc1ccc(-c2ccc(N)c(C(=O)O)c2)cc1C(=O)O]

In embodiments, the aromatic diamine can be:

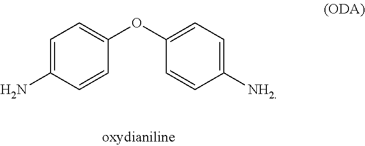 [SMILES: Nc1ccc(Oc2ccc(N)cc2)cc1]

In embodiments, the polyimide can be, but is not limited to:

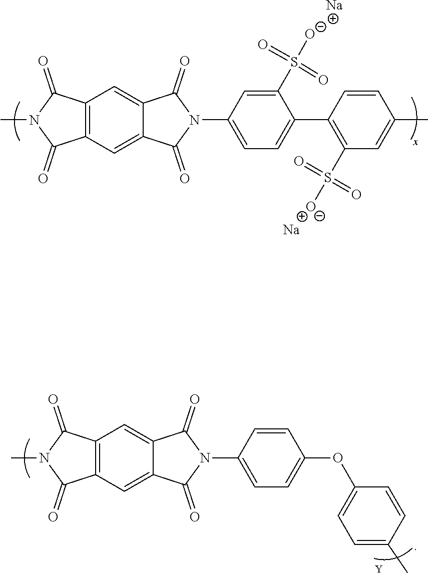

### Methods of Use

A method of producing a three-dimensional object, the method comprising: depositing the ink formulation described herein on a substrate; and irradiating the deposited ink formulation with UV radiation in an amount sufficient to induce curing of the ink formulation, thereby producing a three-dimensional object. In embodiments, the three-dimensional object can be a hydrogel. As used herein, the term “hydrogel” can refer to a 3D polymer network which can retain water within the network.

In embodiments, the substrate can comprise any substrate known in the art. For example, the substrate is a glass plate or a polymer. In embodiments, the wavelength can comprise any wavelength known to induce curing. For example, the wavelength is about 350 nm to about 405 nm. In embodiments, the ink formulation can be exposed to the wavelength for less than about 0.45 sec to about 10 sec. For example, about 0.45 sec, about 0.1 sec, about 0.15 sec, about 0.2 sec, about 0.25 sec, about 0.3 sec, about 0.35 sec, about 0.4 sec, about 0.45 sec, about 0.5 sec, about 0.55 sec, about 0.6 sec, about 0.65 sec, about 0.7 sec, about 0.75 sec, about 0.8 sec, about 0.85 sec, about 0.9 sec, about 1.0 sec, about 1.5 sec, about 2.0 sec, about 2.5 sec, about 3.0 sec, about 3.5 sec, about 4.0 sec, about 4.5 sec, about 5.0 sec, about 5.5 sec, about 6.0 sec, about 6.5 sec, about 7.0 sec, about 7.5 sec, about 8.0 sec, about 8.5 sec, about 9.0 sec, about 9.5 sec, about 10 sec, or greater than about 10 sec.

In embodiments, the method further comprises: drying the three-dimensional object in vacuo; heating the three-dimensional object; and cooling the object. For example the object can be cooled to about 25° C. In embodiments, the vacuum can comprise any vacuum pull sufficient to dry the composition.

In embodiments, the three-dimensional object can be heated to about 200 to about 400° C. For example, the object can be heated to about less than 50° C., about 50° C., about 75° C., about 100° C., about 125° C., about 150° C., about 175° C., about 200° C., about 225° C., about 250° C., about 275° C., about 300° C., about 325° C., about 350° C., about 400° C., about 425° C., about 450° C., about 475° C., about 500° C., or greater than 500° C.

In embodiments, the method further comprises subjecting the three-dimensional object to a freezing temperature overnight; submerging the three-dimensional object in an acetone/dry ice bath; and subjecting the object to imidization.

In embodiments, the freezing temperature can comprise about 0° C. to less than about −80° C. For example, the freezing temperature comprises −24° C. In embodiments, any imidization protocol known in the art can be used. For example, the imidization can comprise thermal or chemical imidization. For example, the imidization can utilize a catalyst.

Aspects of the disclosure are drawn towards a three-dimensional object produced by the methods described herein.

A method of producing a three-dimensional carbonaceous structure, the method comprising: depositing an ink formulation described herein on a substrate; irradiating the deposited ink formulation with UV radiation in an amount sufficient to induce curing of the ink formulation, thereby producing a three-dimensional object; subjecting the three-dimensional object to a freezing temperature overnight; submerging the three-dimensional object in an acetone/dry ice bath; subjecting the three-dimensional object to imidization; and subjecting the three-dimensional object to pyrolysis, thereby producing a three-dimensional carbonaceous structure.

For example, the pyrolysis can take place in an inert atmosphere (e.g., argon). For example, the temperature can be increased to improve graphitic order. For example, the temperature can be ramped incrementally. For example, the temperature can be ramped bat a rate of about 6 C/min. For example, the temperature can be increased to about 1100 C to 2200 C.

As used herein, the term “carbonaceous” refers to a composition comprising carbon. In embodiments, the carbonaceous structure is formed by pyrolysis. As used herein, the terms “carbonizing”, “pyrolyzing”, “carbonization” and “pyrolysis” can refer to the process of heating a carbon-containing substance in an inert atmosphere (e.g., argon, nitrogen or combinations thereof) or in a vacuum such that the targeted material collected at the end of the process is primarily carbon. “Pyrolyzed” can refer to a material or substance, for example a carbon material, which has undergone the process of pyrolysis.

Aspects of the invention are drawn towards a three-dimensional carbonaceous structure produced by a method described herein. In some embodiments, the compositions described herein can be partially or selectively carbonized. In embodiments, any method known in the art can be used to selectively carbonize compositions described herein leading to both structural and conductive components. For example, the selective carbonization can comprise laser-induced graphitization.

In embodiments, the void and/or pore size of the compositions described herein can be controlled during the computer-aided design (CAD) process. For example, macrovoids can be introduced through the selection of postprocessing. For example, dense (micro) carbon structures can be formed by printing, air-drying, and then drying in vacuo before subjecting to thermal post-processing.

In embodiments, microporous structures can be formed by freeze-casting. Among various methods developed for the fabrication of porous materials, can employ the controlled crystallization of a suspension to induce ordered hierarchical porous architectures. Generally, the freeze-casting technique can be a phase segregation process. As a liquid suspension freezes, spontaneous phase segregation gathers the dispersed particles to the space between the solvent crystals, followed by sublimation of the solidified frozen solvent template from the solid to the gas phase under reduced pressure. This creates a three-dimensional network, where the pores become a replica of the solvent crystals. Freeze-casting has been adopted to introduce high porosity into a variety of compact materials, endowing them several new properties and new applications.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

3D Printing Carbon from Aqueous Poly(Amic Acid) Pendant Salts

### Abstract

All-aromatic polyimides serve as versatile precursors for carbon formation due to the high aromatic content and repeating unit planarity, which synergistically facilitate pyrolysis to ordered carbon. Recent publications disclosed facile synthetic methods for the additive manufacturing (3D printing) of all-aromatic polyimides using a pendant salt approach for ultraviolet-assisted direct ink write (DIW) additive manufacturing. Described herein is the introduction of pendant sodium sulfonate functionality to the poly(amic acids), and water-soluble all-aromatic polyimide precursors displayed suitable rheological properties for DIW. These aqueous dispersions facilitate the formation of microporous polyimide structures with a direct freeze-casting method and thermal post-processing to 350° C. Furthermore, porous polyimide 3D structures functioned as efficient carbon precursors when pyrolyzed at 1600° C. under inert atmosphere. Raman spectroscopy revealed carbonized 3D structures with characteristic graphitic and disordered carbon bands, which was indicative of polycrystalline, disordered glassy carbon.

### Non-Limiting Summation

3D all-aromatic polyimide precursors from aqueous direct ink write processes serve as a platform for porous 3D carbonaceous structures for emerging aerospace, transportation, membrane, and electronic technologies.

### Introduction

Carbon is accessible in multiple forms, or allotropes, with wide nano-scale structural diversity, including sp3 tetrahedrons found in diamond and planar sp2 hybridized graphite. The difference in carbon atom configurations found in each allotrope affords a wide range of chemical and physical properties, i.e, high strength from unstrained bond angles in diamond and high electrical conductivity from delocalized π electrons in graphene. In addition to the naturally occurring forms of carbon, synthetic carbon often provides properties far exceeding those of competing materials. Analogous to multiple carbonaceous nanostructures available, several methods are suitable to prepare carbonaceous materials with the preferred method depending on the desired carbon type. Differences in precursor chemical composition and processing conditions ultimately lead to carbon fibers (CF) of similar composition, but with differing material properties, such as elastic modulus and mechanical strength. Although poly(acrylonitrile) (PAN) represents a prolific macromolecular CF precursor, all-aromatic polyimides have garnered interest resulting from their shape retention during carbonization, high graphene conversion, and lack of pore formation from carbonization off-gassing. For example, polyimides derived from pyromellitic dianhydride and oxydianiline (PMDA-ODA) are particularly promising as the rigid repeating unit with alternating electron rich and electron poor units arrange preferentially to increase characteristic charge transfer complexes (CTCs). In addition to CTCs, the highly aromatic content promotes the desirable formation of interchain π-stacking. The presence of these intermolecular interactions encourages both parallel and planar orientation of all-aromatic polyimide mainchains and thus provide efficient transformation to ordered carbonaceous materials.

Direct ink write (DIW) is an extrusion-based additive manufacturing (AM) technique that utilizes computer-controlled deposition of polymeric dispersions or solutions (commonly termed inks) into complex and functional 3-dimensional (3D) structures. In contrast to vat photopolymerization, which employs low viscosity resins, DIW exploits the shear-thinning yield stress behavior characteristic of most polymer melts and solutions. Thus, DIW AM can require careful ink formulation to produce high-resolution bead deposition and subsequent transition to a solid-like state (G′ (solid)>G″ (viscous) moduli) to maintain the desired shape and facilitate layer-by-layer printing. Post-deposition solidification occurs through a temperature or solvent-induced phase change, evaporation of the liquid phase, or photocrosslinking induced gelation using a modified UV-assisted direct ink write process (UV-DIW).¹⁻⁷ UV-DIW facilitates printing of polymeric materials with a wider range of rheological properties as the photochemical-reactivity of the deposited ink is rapid and thus prohibits spreading of the ink. As a result, parts printed with UV-DIW can exhibit higher shape and geometric consistency. However, this technique necessitates inks with photo-reactivity, which can require additions of polymerizable scaffold monomers, incorporation of (meth)acrylates through a post-polymerization modification step, or copolymerization with functional monomers.^{8,9} Polymer AM processes can be transformative, and carbonaceous materials also will benefit from the geometric freedom offered through advanced manufacturing methods, such as 3D printing.¹⁰ The inherent shear-thinning yield stress behavior of polymeric melts and solutions together with compositions of high graphene formation provide a simple route for 3D carbonaceous objects. Fully aromatic polyimides, which are nascently high-performing materials, exhibit efficient graphitization thus providing a straightforward printable polymeric carbon precursor.¹¹⁻¹³ In addition, we disclosed 3D carbonaceous objects produced using photo-curable poly(amic acid) salt (PAAS) precursors with a post-imidization carbonization step to 1000° C.¹⁴

Herein we describe sodium sulfonate-containing, fully aromatic PAAS inks that enable DIW 3D printing of graphitic carbon precursors from water. Neutralization of the poly(amic acid) (PAA) intermediate with a low molecular mass amino ethyl methacrylate provides soluble, photo-curable polyimide precursors with rheological properties aligned with UV-DIW.¹⁵ However, in sharp contrast, previous compositions required polar aprotic solvents to produce homogenous, printable inks. Herein, we describe the unprecedented incorporation of sodium sulfonate functionality in the PAA mainchain using a simple copolymerization strategy, and polyimide precursor electrolytes exhibited water solubility, thus facilitating aqueous AM of 3D polyimide structures from a more sustainable and cost-effective solvent. In addition to fully dense parts, the facile sublimation of ice crystals from frozen printed objects facilitated complex, microporous fully aromatic polyimide structures. After quantitative imidization, the high efficiency of aromatic polyimides to form carbon upon pyrolysis facilitated the fabrication of wholly carbonaceous structures. Herein we describe the unprecedented aqueous 3D printing of porous carbon with access to diverse geometries and microstructures with judicious selection of drying conditions.

### Non-Limiting, Exemplary Results

Synthesis and Rheological Characterization of sPAAS Inks

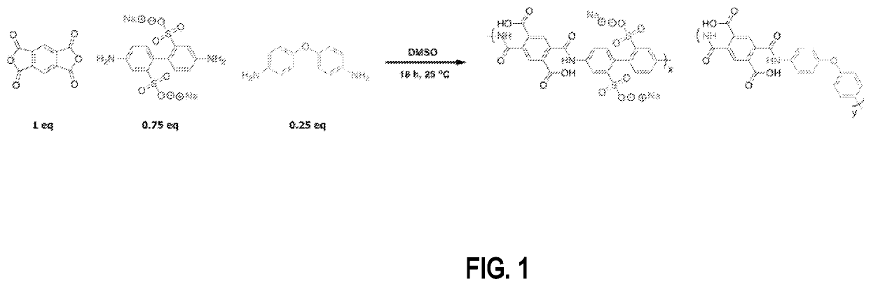

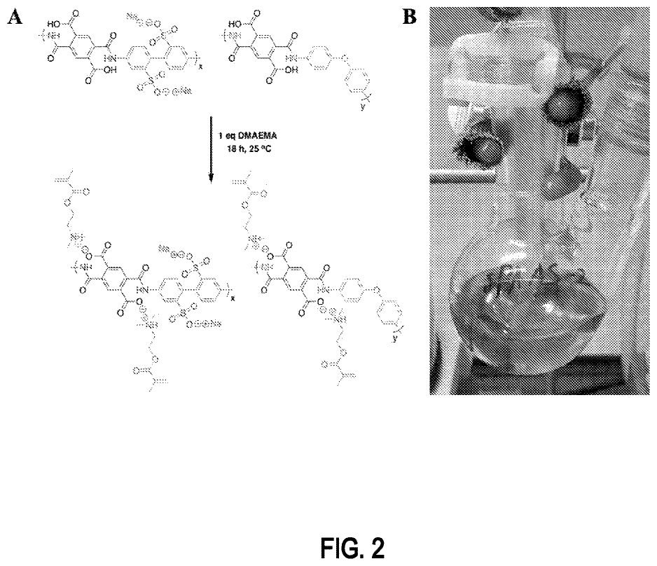

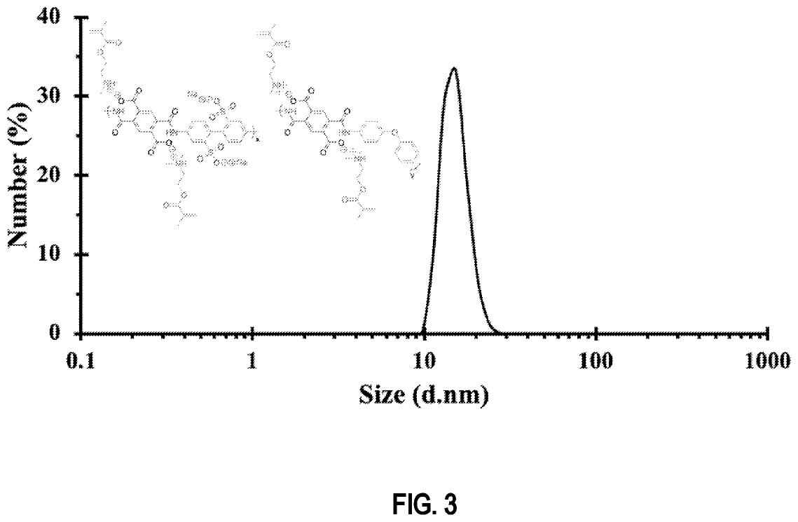

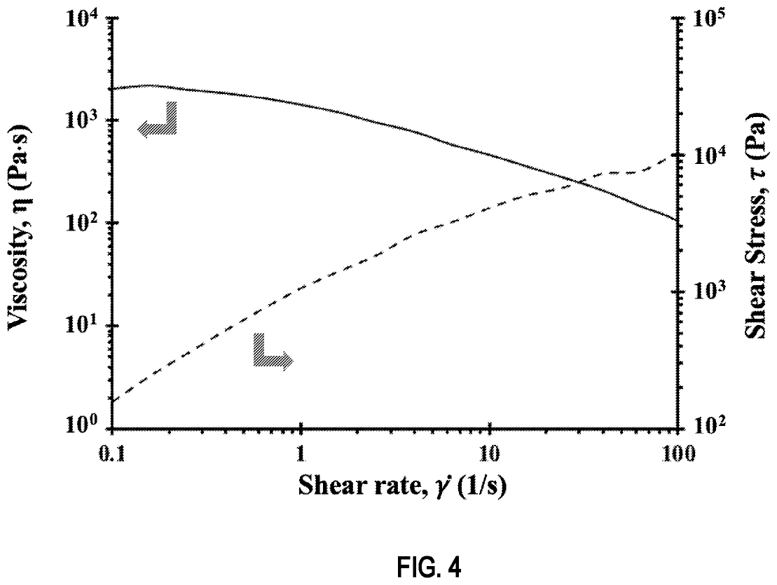

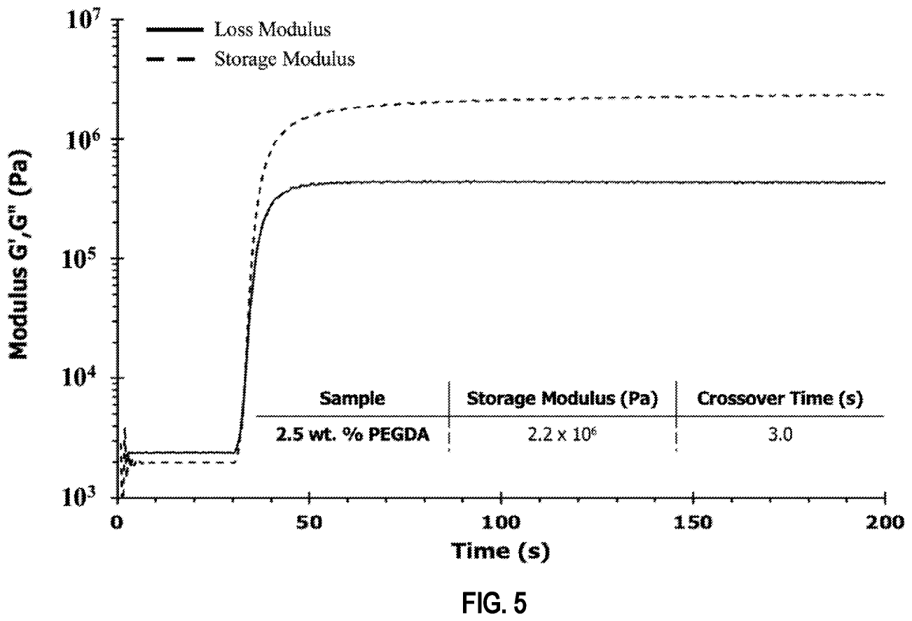

Synthesis of partially sulfonated polyimides was achieved using a conventional solution polyaddition with pyromellitic dianhydride (PMDA) and two aromatic amines: oxydianiline (ODA) and biphenyl disulfonic acid sodium salt (BDSA-Na) (FIG. 1). Dipolar aprotic DMSO ensured sufficient solubility of monomers and the resulting sulfonated poly(amic acids) (sPAA). The sPAA copolymer solution was directly neutralized with an amino-functional methacrylate (DMAEMA) upon completion of the polyaddition reaction, yielding a photo-crosslinkable polyimide precursor. Each sPAA repeating unit contains two carboxylic acids, which provides tunable photo-curing with controlled carboxylic acid-amino-methacrylate stoichiometry. Addition of one molar equivalent of DMAEMA yielded fully neutralized sPAA mainchains with two methacrylate functional groups electrostatically tethered to each repeating unit (FIG. 2). These printable PI precursors are termed sulfonated poly(amic acid) salts (sPAAS). Copolymerization with 0.75 equivalents of sulfonated diamine, BDSA-Na, facilitated water solubility of precipitated sPAAS powders (FIG. 3). Once dissolved, aqueous sPAAS solutions displayed relatively high viscosities, which is prerequisite for the DIW printing process. Addition of a low concentration of 575 g/mol PEGDA served to reduce solution viscosity as neat sPAAS solutions were too viscous to adequately remove air bubbles, which can impart unintended voids in the printed structures. Flow sweep rheology experiments probed the sPAAS ink solution viscosity-shear rate relationship (FIG. 4). This experiment revealed that the sPAAS ink displayed non-Newtonian pseudoplastic shear thinning behavior. The sPAAS ink viscosity remained above the limit for vat photopolymerization despite the addition of a reactive diluent, which indicated the necessity of an extrusion-based process, such as DIW. The ink experiences shear rates of ~50 s⁻¹ during extrusion, thus reducing the viscosity to ~180 Pa·s, which is within the printable range for DIW AM.⁵ In addition, the constant increase in shear stress indicated that the aqueous sPAAS solutions remained homogenous without extended flow instabilities at high shear rates for DIW printing. Subsequent oscillatory photo-rheological experiments revealed the rate of network formation and resultant hydrogel stiffness of sPAAS inks after UV exposure. Photorheology indicated that sPAAS inks reached high plateau storage moduli (G′) with short crossover times (FIG. 5). These experiments collectively indicated that sPAAS inks displayed photo-reactivity that was amenable to UV-assisted DIW.

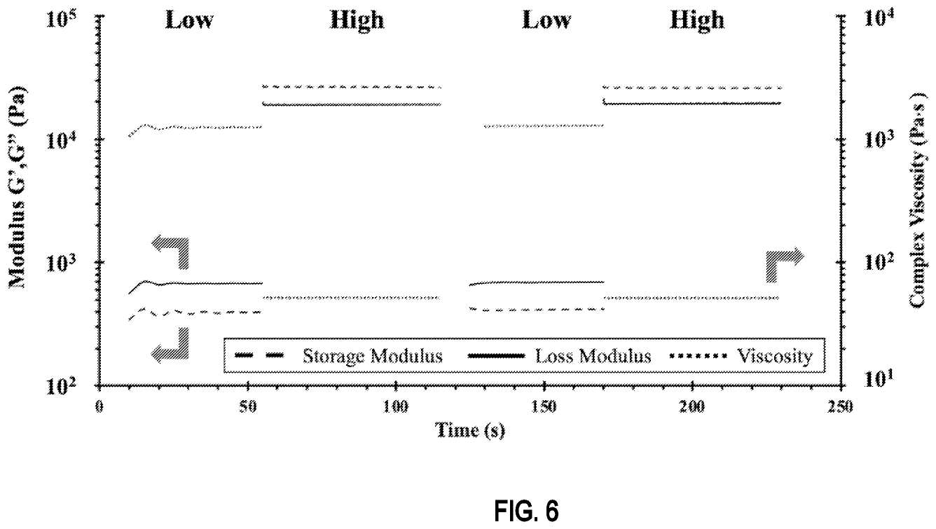

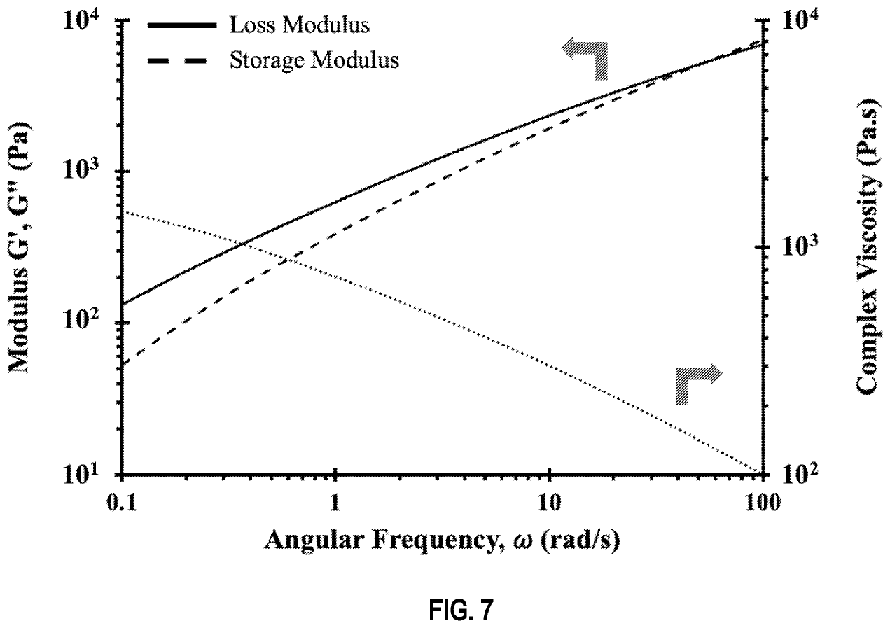

DIW AM can exploit yield-stress behavior to induce flow from a shear stress imparted by the application of pneumatic pressure to the resin vessel. This facilitates ink extrusion through the nozzle, rapid solidification upon deposition, and retention of the deposited geometry upon removal of the applied stress. Harnessing solid-liquid transitions is practiced in DIW processing, wherein G′>G″ indicates elastic solid-like state behavior whereas G′<G″ indicates a liquid-like behavior where the viscous component dominates. A variable frequency oscillatory experiment quantified the extent of shear-thinning and rate of solution microstructure structure recovery (FIG. 6). This experiment applied a low frequency (0.628 rad/s) to represent a solution nearly at rest, and a high frequency (628 rad/s) modeled the ink when exposed to shear stress during extrusion. sPAAS inks exhibited considerable shear-thinning from 1275 to 50 Pas and returned to a higher viscosity state instantaneously once the high shear stress was removed. In addition, the sPAAS inks exhibited more liquid-like properties at low shear rates, and more solid-like behavior is evident at high shear rates with G′/G″ crossover occurring near 100 rad/s (FIG. 7). Thus, the sPAAS ink flowed easily from the nozzle upon the application of pressure and maintained a well-defined bead, which allowed fine control of part geometry. The solution returned to a high viscosity upon deposition, which prevented loss of resolution; however, the liquid-like properties at rest provided sufficient mobility for mixing of the newly deposited and uncured portions of the previous layer. As a result, printed sPAAS structures did not display layer lines. The combination of the variable frequency oscillatory and photo-rheology experiments indicated that sPAAS inks exhibited properties that are suitable for UV-DIW AM.

### 3D Printed and Post-Processing of Carbon Precursors

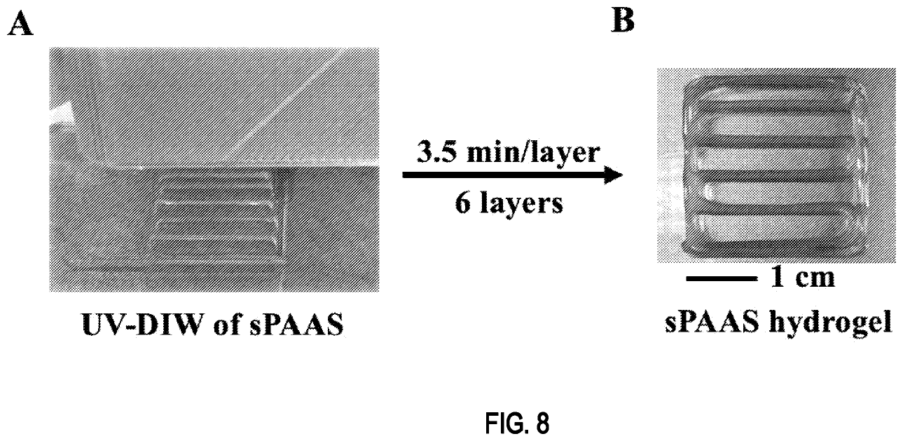

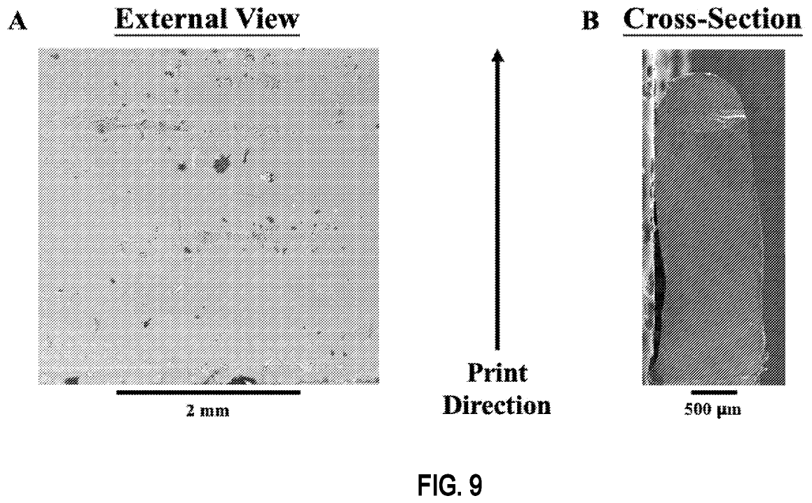

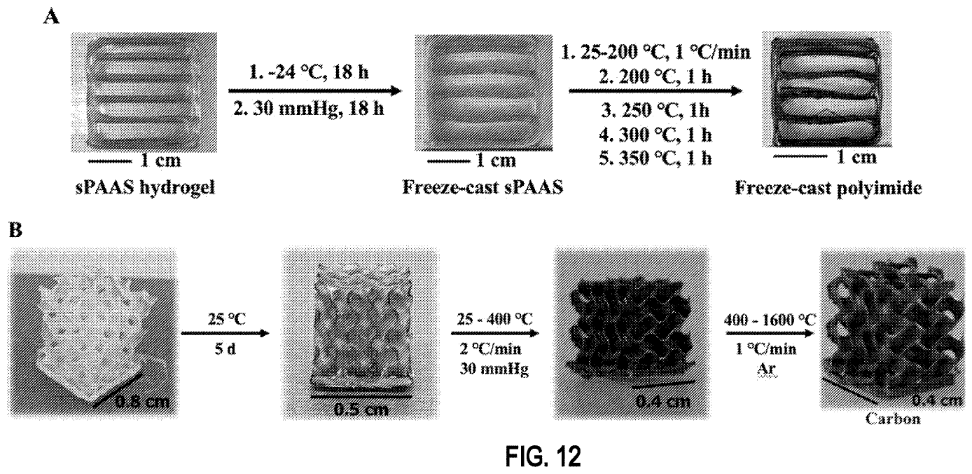

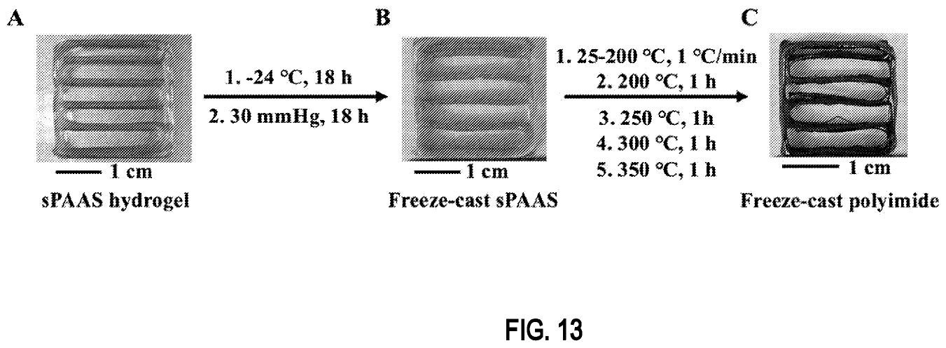

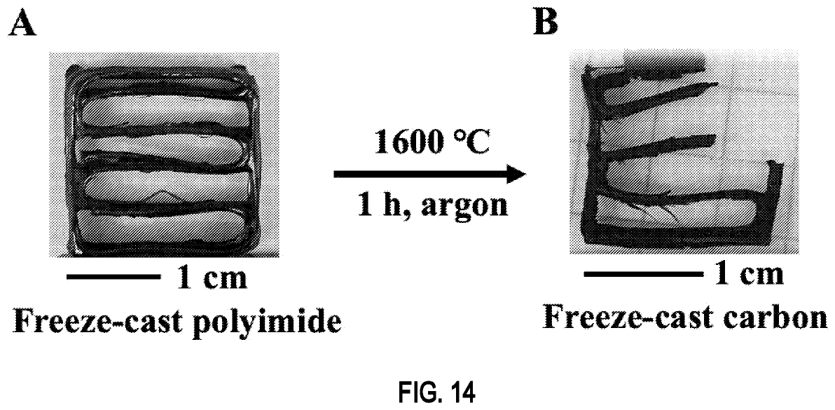

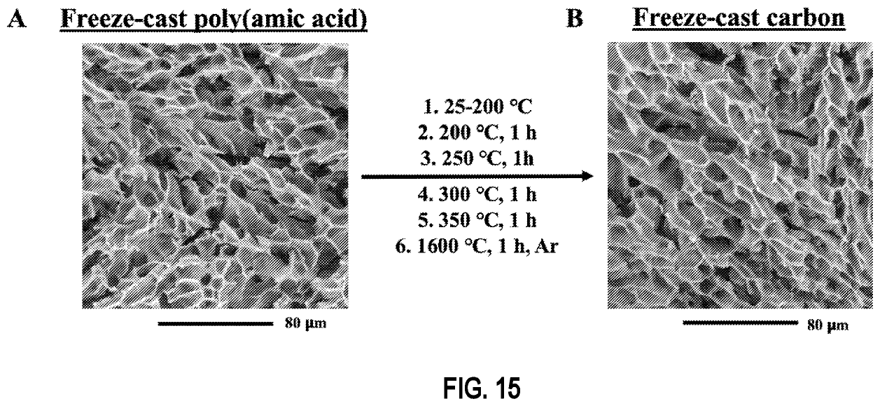

A custom-built UV-DIW apparatus facilitated AM of sPAAS solutions into well-defined 3D shapes (FIG. 8 panel A). As a result of the advantageous rheological properties, a 15-gauge blunt dispensing tip deposited precise sPAAS beads in a layer-by-layer process. The high shear transition to a low viscosity, solid-like, state allowed the bead to maintain the cylindrical shape imparted by the nozzle upon deposition, which allowed high-resolution multi-layer printing (FIG. 8 panel B). Once a layer was deposited, the print was allowed to rest for 30 s before UV irradiation, thus providing sufficient time for viscous flow of the sPAAS ink to form a nearly smooth surface finish with only partially visible layer lines (FIG. 9 panel A). Cross-sectional micrographs displayed the ability of the deposited resin to form a cohesive bond with the partially cured layer directly below (FIG. 9 panel B). Although some visible layer lines remained on the surface, the internal part structure appeared fully dense without layered structure. To further exemplify this, the top layer was cured upon deposition, which resulted in a clear layer line that was visible at the top of the cross-sectional image. In addition to the desirable sustainability of printing an aqueous solution rather than an organic solvent, aqueous solutions allowed for facile production of microporous structures with a subsequent freeze-casting process for the as-printed hydrogels. The printed parts were frozen and placed in a vacuum chamber to facilitate the sublimation of the frozen water. The resulting porous poly(amic acid) structures were subjected to stepwise thermal processing to form the polyimide (FIG. 12) Dried 3D printed polymer solutions resulted in film shrinkage upon densification. However, ice sublimation caused macropore formation, which prohibited shrinkage. The printed sPAAS parts displayed isotropic linear shrinkage of 20% upon thermal cyclodehydration to the sPI. Interestingly, the incorporation of macropores reduced shrinkage during the imidization process, in contrast to previous literature using the pendant salt approach reported linear shrinkage of ~50%.^{15,16}

### Printed Carbon: Microscopy and Spectroscopy

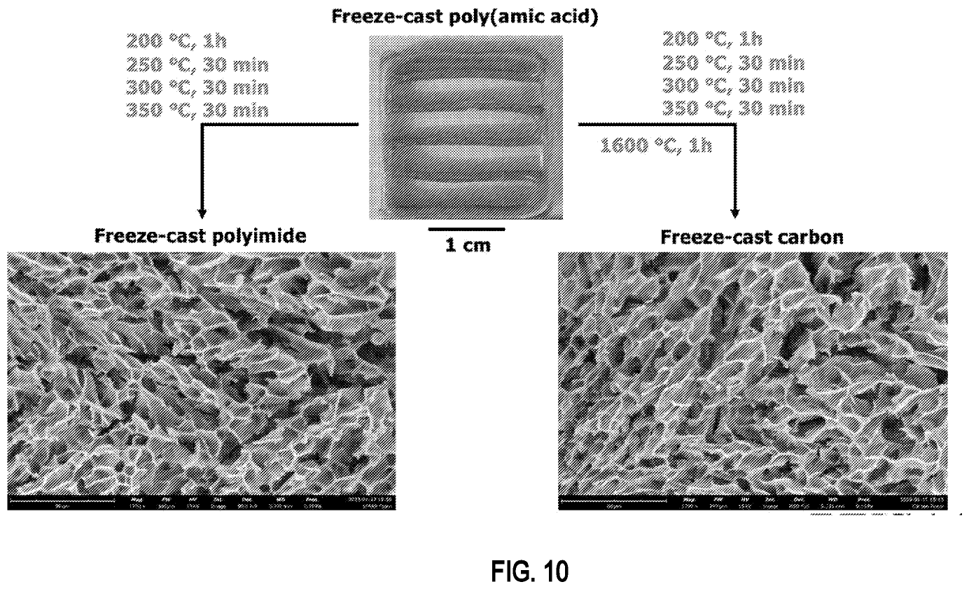

The high aromatic content and planarity of the all-aromatic polyimide was leveraged to produce carbonaceous structures directly from the imidized part. After cooling to 25° C., the printed carbonaceous parts were fractured and analyzed with scanning electron microscopy (SEM). SEM indicated complete retention of the microcellular structure imparted through the direct freeze-casting process and subsequent carbonization (FIG. 10). The pores present in both poly(amic acid) and carbon structures ranged from 10-70 μm and were oriented with the blowing direction.

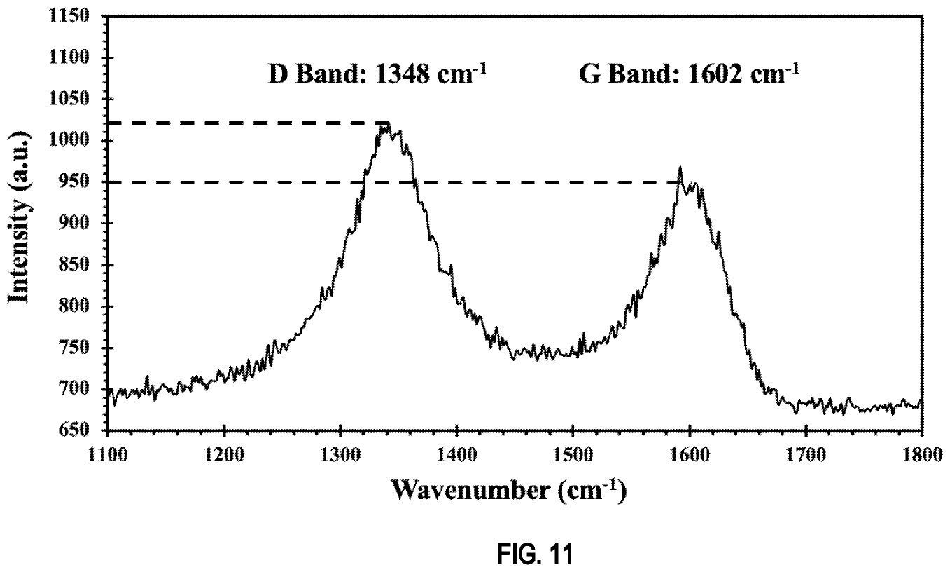

Raman spectroscopy can be employed for the characterization of carbonaceous structures, and thus, Raman elucidated the relative order of the carbon derived from microporous printed sPI structures. When interpreting Raman spectra for carbon, two significant peaks determine the structure: disordered carbon (D) at 1348 cm⁻¹ and ordered graphitic carbon (G) at 1602 cm⁻¹.¹⁷⁻¹⁹ The breadth and intensity of the D band relative to the G band indicated the formation of a turbostratic carbon structure through the carbonization process (FIG. 11). Preceding literature supports this assignment as temperatures exceeding 2000° C. are required to mobilize vacancies, or defects, which allows further crystallite growth in polyimide derived carbon.²⁰ In addition, broadening of the G band often arises from the presence of polycrystalline graphite, which, without wishing to be bound by theory, can be established by the microporous structure as the void space limits the development of preferential crystallite orientation.²¹ Reports have also indicated that graphitic order of sPAAS derived carbon resembles previously reported carbonaceous structures resulting from the carbonization of PAAS.¹⁴ However, the non-sulfonated precursor solutions necessitated the use of dipolar aprotic solvents (NMP). Furthermore, PAA derived PMDA-ODA films exposed to carbonization conditions displayed primarily disordered character until thermal treatment exceeding 2200° C. Thus, without wishing to be bound by theory, sPAAS-derived carbon will exhibit increasingly ordered structures with further thermal treatment above 2500° C.^{22,23}

The low resin viscosity requirement can be the constraining factor for applications of macromolecular precursors in vat photopolymerization (VP) AM as the recoating step is mass transport limited. Although the sPAAS inks exhibited solution viscosities that were prohibitive of VP, judicious application of heat to the resin vat during printing reduced the viscosity to that sufficient for a digital light processing (DLP) printer. The aqueous sPAAS inks facilitated facile high-resolution prints (FIG. 12) of unsupported latices and gyroids from the same feedstock employed in the room temperature UV-DIW process. Through the application of VP, complex 3D structures of greater resolution and lower minimum feature sizes are accessible, thus indicating the versatility offered by the sPAAS aqueous approach.

### Discussion

Herein, we describe a facile approach for 3D printing highly graphitizing aromatic polyimides from water as an advanced manufacturing avenue for more sustainable carbonaceous materials. The versatility facilitated by the aqueous inks facilitates microstructural control through selective drying conditions: room temperature water removal in vacuo for solid parts & freeze-cast ice sublimation for porous parts. The compositions described herein can provide for the production of dense structural carbon and high surface area, microporous carbon for separation and catalysis applications from a more sustainable process.

Literature describes graphite formation from fully aromatic polyimides and efficient expulsion of mainchain heteroatoms, and thus an effective carbon precursor. This research demonstrates the distinct advantages provided by the complement of carbonization mechanisms and facile 3D printing of PAAS precursors reported by our research group. However, the work described herein reports expanded versatility of the PAAS approach to access both dense and microcellular carbonaceous structures with aqueous inks through the incorporation of a sodium sulfonate-containing comonomer. SEM elucidated densified printed parts when the newly deposited layer was allowed to flow briefly before setting with UV exposure. Parts printed with DIW can display readily visible layer lines, which contribute to characteristic anisotropic mechanical properties. However, sPAAS inks display a high propensity for densification, derived from the combination of favorable rheological properties and preferential interchain interactions found in fully aromatic polyimides. Conversely, if the parts are alternatively subjected to established freeze-casting procedures, homogenous internal porous microstructures are achieved. Leveraging the sublimation of solid ice crystals avoids pore collapse consequent of strong capillary forces that imparted by drying liquid filled pores.²⁴ In addition, the tendency of rigid and semi-rigid polyimide mainchains to preferentially order on the nanoscale imparts internal stresses, which contribute to pore collapse in porous polyimides.²⁵ However, the freeze-cast sPAAS derived polyimide structures can be free from either of these deleterious processes. Thus, the intermediate porous polyimide structures were retained without the need for conventional conditioning treatments employed to prohibit pore collapse.^{26,27} Consequently, the described sulfonated polyimide composition serves as an effective carbon precursor resulting from the low susceptibility to pore collapse facilitated by the combination of molecular structure and processing conditions. To further improve the relative carbon order, carbonization exceeding 2500° C. is suitable.²⁸ Without wishing to be bound by theory, the resulting materials can display enhanced mechanical properties and compositional regularity for reactive carbon scaffolds.

In summary, we synthesized a new, water soluble, photocurable sPAA ink, which provided served as a simplistic approach to varied macro- and microstructures through selective processing conditions. An exemplary advantage described herein is the ability to manufacture 3D carbonaceous objects from water. Methodologies used herein to achieve this were shown to have little effect on the resulting carbon order and provided materials with comparable Raman spectra to those produced that failed to adhere to key principles of green chemistry: use of renewable feedstocks, safer solvents and auxiliaries, and design for energy efficiency.¹⁴ Carbonaceous materials display a multitude of desirable thermal, electrical, and mechanical properties but can suffer from stringent processing conditions. Described herein is a more sustainable approach to complex large-scale 3D carbon fabrication free from high-boiling point solvents, which previously convoluted post-printing drying steps and instead, utilized a low-cost environmentally friendly solvent, water. The macro- and microstructure control facilitated by 3D-printable aqueous sPAAS inks provides an avenue to produce next-generation catalysts, membranes, and energy storage materials.

### Materials and Methods

### Materials

Pyromellitic dianhydride (PMDA) (Acros; purity, >99%) and 4,4′-oxydianiline (ODA) (Sigma-Aldrich; purity, 97%) were sublimed immediately prior to use. 2,2′-benzidinedisulfonic acid (BDSA) (TCI; <30% water) was purified as outlined below. 2-dimethylamino methylmethacrylate (DMAEMA) (Sigma Aldrich; purity, 98%, 700 ppm hydroquinone), deuterium oxide (D₂O) (Sigma Aldrich, 99.9% D), hydrochloric acid (Fisher Chemical, certified ACS), and anhydrous dimethyl sulfoxide (DMSO) (Acros Organics, 99.7+%, extra dry over molecular sieves) were used as received. Lithium acylphosphinate photoinitiator was prepared as outlined in literature.⁶

### Analytical Methods

Photo-rheological experiments were performed on a TA Instruments DHR-3 at 25° C. These measurements were made on a Smart Swap™ geometry with an Omnicure® S2000 high-pressure mercury light source with a 320-500 nm filter, 20 mm disposable aluminum parallel plate, and a 20 mm quartz parallel plate lower geometry with a 500 μm gap. UV intensity was measured using a Silverline radiometer with a 20 mm attachment. Measurement parameters were set with a sampling frequency of 1 Hz, 0.1% strain, and 250 mW·cm⁻² UV intensity. The samples were exposed to UV light 30 s into the experiment for 15 s. The data was analyzed using the TA Instruments TRIOS software to identify the storage modulus (G′), loss modulus (G″), and crossover time. Solution rheology was performed on a TA Instruments DHR-3 at 25° C. in water on a Smart Swap™ Peltier plate lower geometry with a 25 mm parallel upper geometry and a 300 μm gap. A Thermo Scientific Phenom XL large stage scanning electron microscope provided images of the surfaces and cross sections of the 3D printing specimens. In situ FTIR spectroscopic experiments were performed with a Mettler Toledo React IR-15 with a Si composite probe, 3 min resolution, and 128 scans. Raman spectroscopy was performed with a custom-built system with a 532 nm laser.

### Purification of BDSA-Na Monomer

4,4′-diaminodiphenyl-2,2′-disulfonic acid (50.0 g) was added to a 500 mL round-bottomed flask with water (250 mL) and sodium hydroxide (8.34 g, 0.2085 mol). This solution was precipitated in ethanol (300 mL) and stirred for 5 min. The BDSA-Na salt was collected with a vacuum filter and allowed to dry for 10 min. The dry BDSA-Na was added to a 250 ml round-bottomed flask with water (125 mL) and upon observation of a homogenous solution, HCl (67.5 mL, 1.851 mol) was added. The mixture was cooled at 0° C. in an ice bath for 5 min and the product collected in a vacuum filter. This process was repeated four times to provide pure BDSA-Na, now a white powder, with an overall yield of 50%.

Synthesis of Fully Neutralized sPAAS Copolymer

4,4′-oxydianiline (2.34 g, 0.0114 mol), BDSA-Na (13.4 g, 0.0344 mol), and anhydrous DMSO (93 mL) were added to a flame-dried two-neck, round-bottomed flask fitted with a glass mechanical stir rod with a Teflon™ paddle. The heterogeneous solution was stirred until complete dissolution of ODA and dispersion of BDSA-Na. To this, pyromellitic dianhydride (10 g, 0.0458 mol) was added and the mixture stirred for 18 h to provide a transparent sPAA solution. DMAEMA (14.4 g, 0.0917 mol) was added, and the mixture stirred for 18 h, thus providing a photo-crosslinkable sPAAS solution. Anhydrous DMSO (20 mL) was added to reduce the solution viscosity and then the mixture was precipitated into acetone (2 L). This material was dried in vacuo at 40° C. for 18 h.

Preparation of Aqueous sPAAS Inks

To obtain an ink, sPAAS (20 g) was added to a 100 mL round-bottomed flask and allowed to dry in vacuo for 3 h. Water (60 g) and PEGDA 575 (0.51 g, 0.46 mL) were added and allowed to rest for 24 h. Once a homogenous mixture was observed, LAP photoinitiator (0.53 g, 1.79 mmol) was added, the solution heated to 70° C., and mixed with a vortexer to disperse the solid amongst the solution and facilitate the removal of air bubbles. This solution was mixed for 1 h and yielded a transparent, bubble-free, homogenous sPAAS ink.

### UV-Assisted Direct Ink Write Additive Manufacturing

A custom-built UV-assisted direct ink write system was used to fabricate three-dimensional parts with aqueous sPAAS inks comprised of 25 wt. % sPAAS, 2.5 wt. % PEGDA 575, and 2.5 wt. % LAP photoinitiator. A ShopBot® D2418 desktop CNC machine equipped with a Nordson Ultimus™ V EFD facilitated deposition of sPAAS inks on a glass substrate with a layer height of 1.27 mm, lateral speed of 6.35 mm/min, and 50 psi of pressure applied to the vessel. Following complete deposition of each layer, the print was allowed 30 s of rest before irradiation with a Dymax® BlueWave® QX4™ LED spot-curing system with a Visicure™ 405 nm head at 14 mW/cm² for 10 s.

### Post-Printing Process for Dense Parts

The crosslinked hydrogels were removed from the glass substrate and allowed to dry in ambient conditions on a steel mesh until no tack remained. After this, the printed parts were dried in vacuo at 30 mmHg for one day at 25° C. The temperature was then increased to 50° C. and held for one hour before ramping to 200° C. with a heating rate of 2° C./min. After cooling to 25° C., the objects were transferred to a glass vacuum chamber, submerged in a metal (Bi—Sn alloy) bath, gradually heated to 400° C., and then cooled to 25° C.

### Post-Printing Process for Freeze-Cast Parts

Crosslinked hydrogels were removed from the glass substrate and immediately frozen at −24° C. overnight. The objects were transferred to a glass vacuum chamber, submerged in an acetone/dry ice bath, and allowed to cast for 18 h at 0.4 mmHg. The objects were exposed to the same imidization conditions previously described.

### Carbonization of AM PI Structures

The imidized objects were placed in alumina sample holders in a quartz tube furnace and heated under a constant purge of argon to 1600° C. with a heating rate of 1° C./min. The samples were held at 1600° C. for one hour before returning to 25° C.

### REFERENCES CITED IN THIS EXAMPLE

(1) Wang, Y.; Willenbacher, N. Phase-Change-Enabled, Rapid, High-Resolution Direct Ink Writing of Soft Silicone. Adv. Mater. 2022, 34 (15), 2109240.
(2) Boley, J. W.; Chaudhary, K.; Ober, T. J.; Khorasaninejad, M.; Chen, W. T.; Hanson, E.; Kulkarni, A.; Oh, J.; Kim, J.; Aagesen, L. K.; et al. High-Operating-Temperature Direct Ink Writing of Mesoscale Eutectic Architectures. Adv. Mater. 2017, 29 (7), 1604778.
(3) Dong, J.; Li, Y.; Lin, P.; Leeflang, M. A.; van Asperen, S.; Yu, K.; Tümer, N.; Norder, B.; Zadpoor, A. A.; Zhou, J. Solvent-Cast 3D Printing of Magnesium Scaffolds. Acta Biomater. 2020, 114, 497-514.
(4) Chausse, V.; Schieber, R.; Raymond, Y.; Ségry, B.; Sabaté, R.; Kolandaivelu, K.; Ginebra, M.-P.; Pegueroles, M. Solvent-Cast Direct-Writing as a Fabrication Strategy for Radiopaque Stents. Addit. Manuf. 2021, 48, 102392.
(5) Scott, P. J.; Rau, D. A.; Wen, J.; Nguyen, M.; Kasprzak, C. R.; Williams, C. B.; Long, T. E. Polymer-Inorganic Hybrid Colloids for Ultraviolet-Assisted Direct Ink Write of Polymer Nanocomposites. Addit. Manuf. 2020, 35, 101393.
(6) Wu, T.; Jiang, P.; Ji, Z.; Guo, Y.; Wang, X.; Zhou, F.; Liu, W. 3D Printing of High-Performance Isocyanate Ester Thermosets. Macromol. Mater. Eng. 2020, 305 (11), 2000397.
(7) Ma, C.; Wu, S.; Ze, Q.; Kuang, X.; Zhang, R.; Qi, H. J.; Zhao, R. Magnetic Multimaterial Printing for Multimodal Shape Transformation with Tunable Properties and Shiftable Mechanical Behaviors. ACS Appl. Mater. Interfaces 2021, 13 (11), 12639-12648.
(8) Arrington, C. B.; Rau, D. A.; Williams, C. B.; Long, T. E. UV-Assisted Direct Ink Write Printing of Fully Aromatic Poly(Amide Imide) s: Elucidating the Influence of an Acrylic Scaffold. Polymer (Guildf). 2021, 212 (December 2020), 123306.
(9) Wu, T.; Jiang, P.; Zhang, X.; Guo, Y.; Ji, Z.; Jia, X.; Wang, X.; Zhou, F.; Liu, W. Additively Manufacturing High-Performance Bismaleimide Architectures with Ultraviolet-Assisted Direct Ink Writing. Mater. Des. 2019, 180, 107947.
(10) Fu, K.; Yao, Y.; Dai, J.; Hu, L. Progress in 3D Printing of Carbon Materials for Energy-Related Applications. Adv. Mater. 2017, 29 (9), 1603486.
(11) Inagaki, M.; Harada, S.; Sato, T.; Nakajima, T.; Horino, Y.; Morita, K. Carbonization of Polyimide Film “Kapton.” Carbon N. Y. 1989, 27 (2), 253-257.
(12) Konno, H.; Shiba, K.; Kaburagi, Y.; Hishiyama, Y.; Inagaki, M. Carbonization and Graphitization of Kapton-Type Polyimide Film Having Boron-Bearing Functional Groups. Carbon N. Y. 2001, 39 (11), 1731-1740.
(13) Inagaki, M.; Tachikawa, H.; Nakahashi, T.; Konno, H.; Hishiyama, Y. The Chemical Bonding State of Nitrogen in Kapton-Derived Carbon Film and Its Effect on the Graphitization Process. Carbon N. Y. 1998, 36 (7-8), 1021-1025.
(14) Arrington, C. B.; Rau, D. A.; Vandenbrande, J. A.; Hegde, M.; Williams, C. B.; Long, T. E. 3D Printing Carbonaceous Objects from Polyimide Pyrolysis. ACS Macro Lett. 2021, 10 (4), 412-418.
(15) Rau, D. A.; Herzberger, J.; Long, T. E.; Williams, C. B. Ultraviolet-Assisted Direct Ink Write to Additively Manufacture All-Aromatic Polyimides. ACS Appl. Mater. Interfaces 2018, 10 (41), 34828-34833.
(16) Herzberger, J.; Meenakshisundaram, V.; Williams, C. B.; Long. T. E. 3D Printing All-Aromatic Polyimides Using Stereolithographic 3D Printing of Polyamic Acid Salts. ACS Macro Lett. 2018, 7 (4), 493-497.
(17) Schwan, J.; Ulrich, S.; Batori, V.; Ehrhardt, H.; Silva, S. R. P. Raman Spectroscopy on Amorphous Carbon Films. J. Appl. Phys. 1996, 80 (1), 440-447.
(18) Jawhari, T.; Roid, A.; Casado, J. Raman Spectroscopic Characterization of Some Commercially Available Carbon Black Materials. Carbon N. Y. 1995, 33 (11), 1561-1565.
(19) Beeman, D.; Silverman, J.; Lynds, R.; Anderson, M. R. Modeling Studies of Amorphous Carbon. Phys. Rev. B 1984, 30 (2), 870-875.
(20) Bourgerette, C.; Oberlin, A.; Inagaki, M. Structural and Textural Changes from Polyimide Kapton to Graphite: Part I. Optical Microscopy and Transmission Electron Microscopy. J. Mater. Res. 1992, 7 (5), 1158-1173.
(21) Katagiri, G.; Ishida, H.; Ishitani, A. Raman Spectra of Graphite Edge Planes. Carbon N. Y. 1988, 26 (4), 565-571.
(22) Ghosh, M. K.; Mittal, K. L. Polyimides: Fundamentals and Applications; Marcel Dekker: New York, 1996.
(23) Inagaki, M.; Ohta, N.; Hishiyama, Y. Aromatic Polyimides as Carbon Precursors. Carbon N. Y. 2013, 61, 1-21.
(24) Siddique, H.; Bhole, Y.; Peeva, L. G.; Livingston, A. G. Pore Preserving Crosslinkers for Polyimide OSN Membranes. J. Memb. Sci. 2014, 465, 138-150.
(25) Hedrick, J. High Temperature Nanofoams Derived from Rigid and Semi-Rigid Polyimides. Polymer (Guildf). 1995, 36 (14), 2685-2697.
(26) GEVERS, L.; ALDEA, S.; VANKELECOM, I.; JACOBS, P. Optimisation of a Lab-Scale Method for Preparation of Composite Membranes with a Filled Dense Top-Layer. J. Memb. Sci. 2006, 281 (1-2), 741-746.
(27) Beerlage, M. A. Polyimide Ultrafiltration Membranes for Non-Aqueous Systems; Universiteit Twente, 1994.
(28) Inagaki, M.; Meng, L.-J.; Ibuki, T.; Sakai, M.; Hishiyama, Y. Carbonization and Graphitization of Polyimide Film “Novax.” Carbon N. Y. 1991, 29 (8), 1239-1243.

### Example 2

3D Printing of Carbonaceous Structures from Water

### Non-Limiting, Exemplary Disclosure Summary

Graphene is comprised of sp2 hybridized carbon atoms in a single layer. Previous reports of printable carbon precursor macromolecules employ organic solvents to solubilize high carbon content macromolecules, which are hydrophobic and thus, are not water soluble. The molecular design of these new materials facilitate the use of water as a solvent, which is more sustainable and environmentally friendly.

Described herein is the design and synthesis of aromatic polyimide-based precursors for the formation of carbon-based 3D structures from aqueous-based inks. The polyimide precursors have been modified by incorporating sodium sulfonate groups into the mainchain of the polymer making the polymers water soluble for the formation of aqueous-based inks for 3D printing. Printing is followed by drying and pyrolyzation to form 3D geometrically complex carbonaceous structures. The use of aqueous inks allows for a more sustainable approach to 3D fabrication that is free from high-boiling point, organic-based solvents which can lead to problems in post-printing and drying steps.

### Non-Limiting, Exemplary Surprising Features of the Disclosure

Aromatic polyimides are functionalized with sodium sulfonate groups to make them water soluble.
3D printable, water soluble inks are formed that can be printed followed by drying and pyrolyzation to form 3D carbonaceous structures.

The synthesis of polyimides functionalized with sodium sulfonate groups is described herein. The functionalized polyimides were used to make water soluble inks that were printed, dried and pyrolyzed to make 3D carbonaceous structures that were tested and characterized.

### Example 3

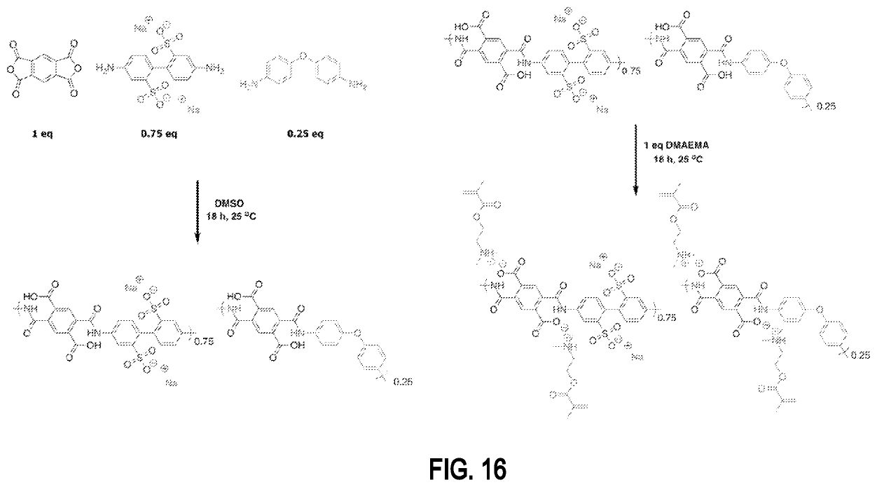

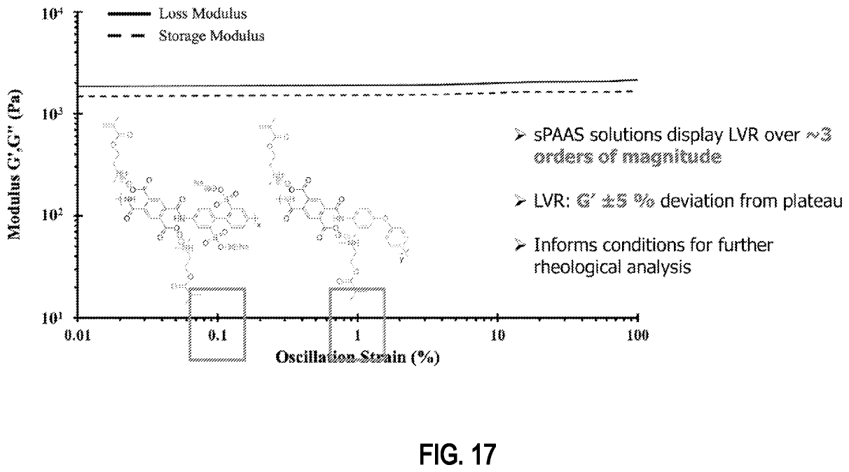

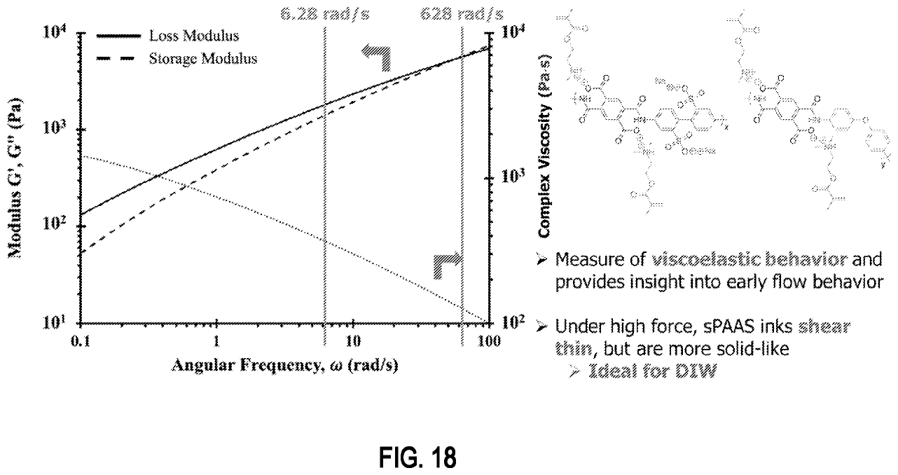

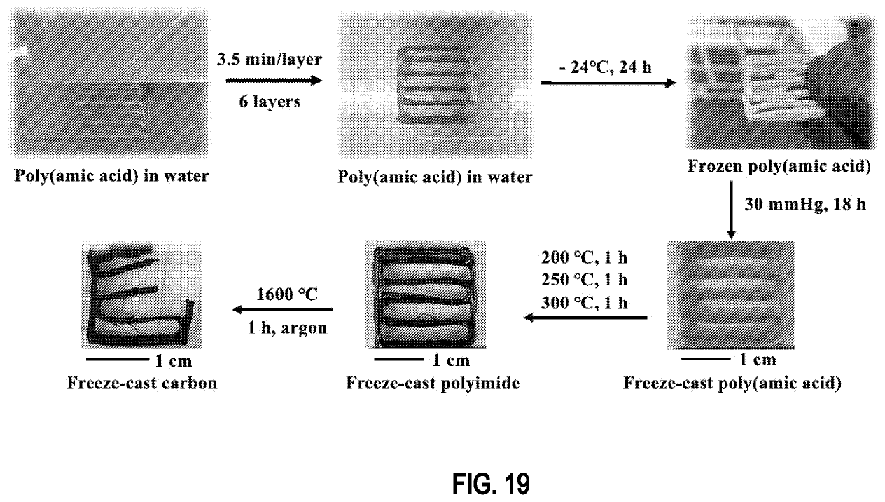

Two-step synthetic method affords water-soluble and photocurable polyimide precursors (FIG. 16)
Dynamic light scattering showcases water solubility of fully-neutralized sPAAS (FIG. 3). Performed on Malvern Zeta Sizer—1.5 wt. % in water.
Amplitude (strain) sweep showcases long linear viscoelastic region for sPAAs solutions (FIG. 17). This provides information on the microstructure of the sample. Performed on TA DHR-3 w/Peltier Plate, 25 mm parallel plate, 300 μm gap, 25 wt. % in water, 1.6 Hz or 10 rad/s.
Frequency sweep unveils G′/G″ crossover at high angular frequencies (FIG. 18). Performed on TA DHR-3 w/Peltier Plate, 25 mm parallel plate, 300 μm gap, 25 wt. % in water, 1 Hz, 1% strain.
Flow sweep elucidates shear induced flow of sPAAS ink is amenable to extrusion processes (FIG. 4). Performed on TA DHR-3 w/Peltier Plate, 25 mm parallel plate, 300 μm gap, 25 wt. % in water, 1 Hz, 1% strain. This measures properties under extended periods of flow. sPAAS inks shear thin and flows smoothly. This can be ideal for deposition of smooth beads.
Sulfonated poly(amic acid) s salts provide avenue for printable, water-soluble carbon precursor (FIG. 5). Performed on TA DHR-3 w/Photo-accessory, 20 mm parallel plate, 300 μm gap, 1 Hz, 0.1% strain, 25 wt. % in water, 2.5 wt. % LAP. It cures easily and forms stiff, easily handled hydrogels. This simplifies post-processing steps.
Variable frequency experiment displays rheological transitions that are ideal for DIW (FIG. 6). Performed on TA DHR-3 w/Peltier Plate, 25 mm parallel plate, 300 μm gap, 25 wt. % in water, Low: 6.28, 0.1% strain, High: 628 Hz, 1% strain.
UV-assisted direct ink write of aqueous sPAAS solutions provides well defined 3D structures (FIG. 19). Conditions: UV-assisted DIW, 25 wt. % sPAAS, 2.5 wt. % PEGDA, 2.5 wt. % LAP in water.
Freeze-cast microcellular structure is retained though carbonization to 1600° C. Performed on ThermoFisher Phenom XL-15 kV.
Raman spectroscopy showcases production of primarily disordered carbon during sPAAS carbonization (FIG. 11).

$$\frac{{I}_{D}}{{I}_{G}} = \frac{1007}{950} = 1.06 ,$$

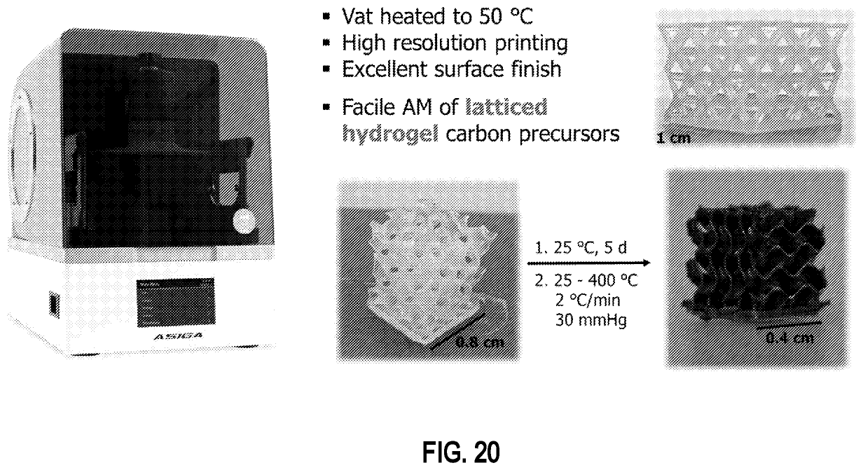

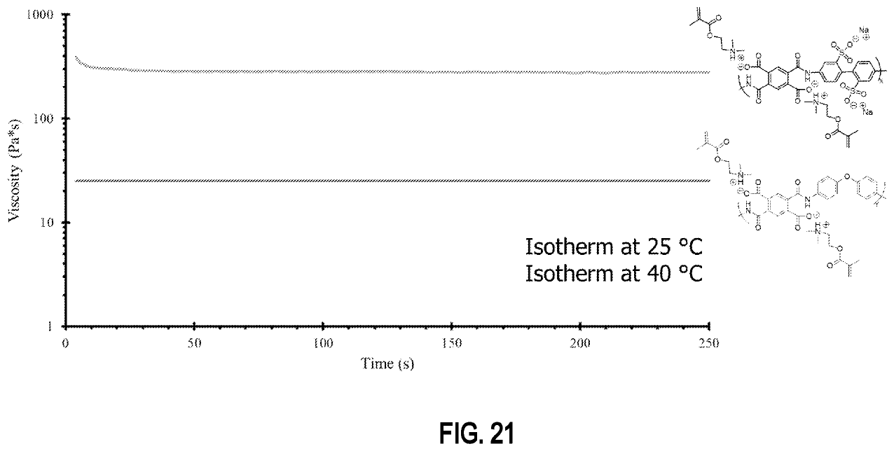

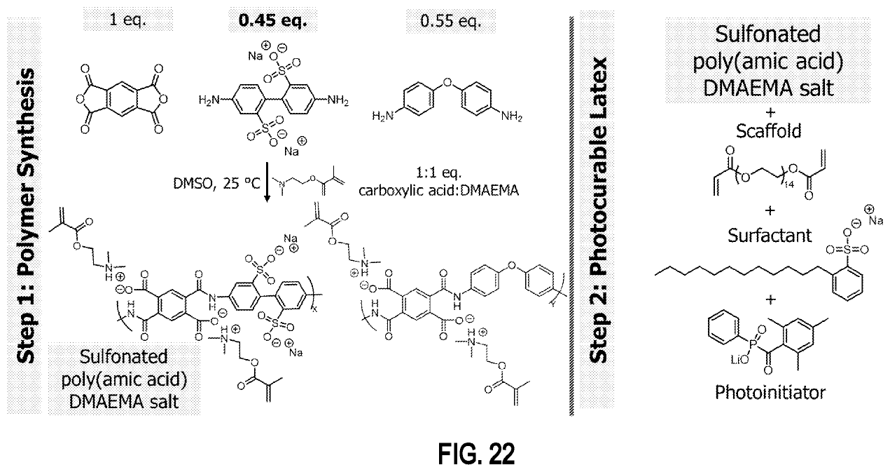

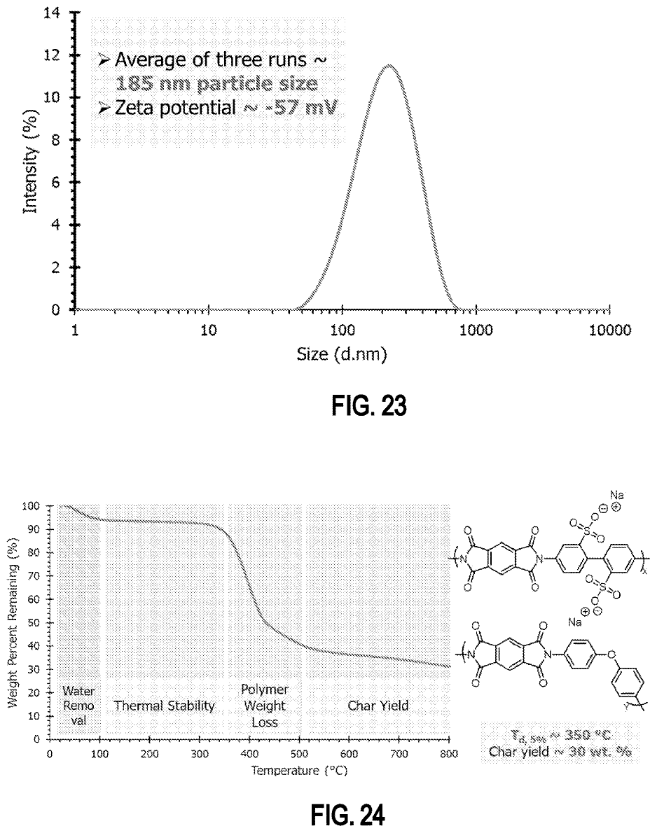

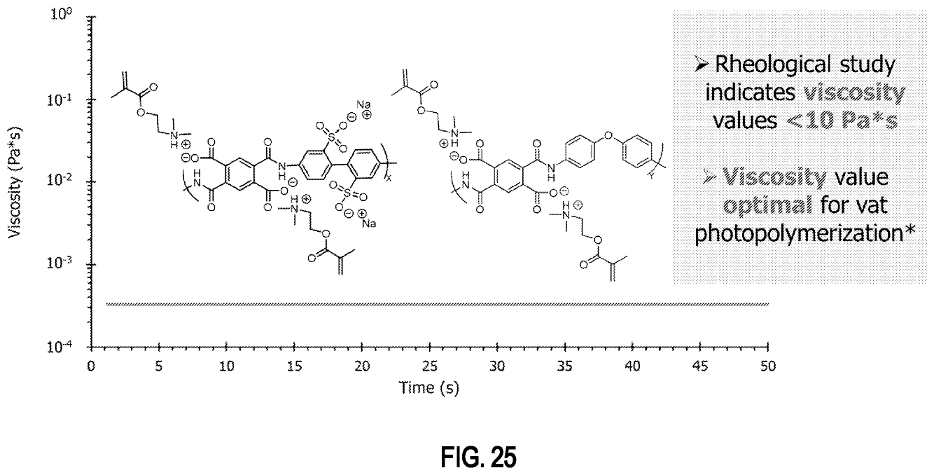

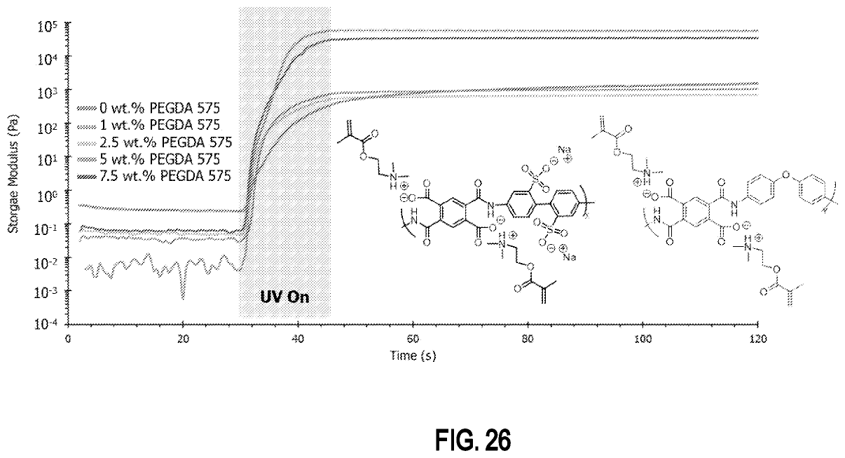

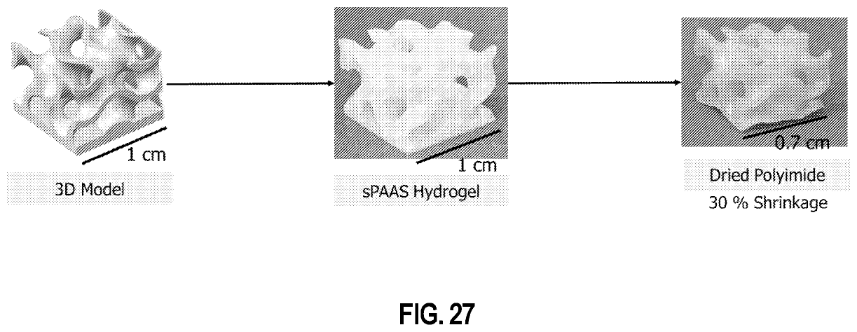

graphene I_{D}/I_{G}=0. Indicates formation of disordered carbon structures. See, Zafar et al. Carbon, 2013, 61, 57-62.
Judicious application of heat facilitates vat photopolymerization of sPAAS solutions (FIG. 20).
Increasing temperature allows reduction in viscosity. TA HR-30, 25 mm parallel plate, 500 μm gap, 10 rad/s shear rate, 1 s/pt sample rate∥10 wt. % solids in water (FIG. 21).
Leveraging latex platform to synthesize aqueous polyimide precursor (FIG. 22).
Particle size of 185 nm with negative zeta potential indicates stable dispersion in water (FIG. 23); Malvern Zeta Sizer—1.5 wt. % in water.
High T_{d}, 5% and char yield after pyrolysis of polyimide film indicates high thermal stability (FIG. 24). TGA5500 under N₂, ramp @ 10° C./min, 25° C. to 1000° C.∥Polyimide film: 10 wt. % solids in water, heated to 400° C. under N₂.
Solution rheology indicates optimal rheological behavior for vat photopolymerization (FIG. 25). TA HR-30, 25 mm parallel plate, 500 μm gap, 10 rad/s shear rate, 1 s/pt sample rate∥10 wt. % solids in water. *Weyhrich, C. W.; Will, J.; Nayyar, G.; Westover, C. C.; Patterson, S.; Arrington, C. B.; Williams, C.; Timothy Edward Long. Temporally Stable Supramolecular Polymeric Salts Enabling High-Performance 3D All-Aromatic Polyimide Lattices. Small 2023, 19 (32).
High plateau storage modulus allows robust PI hydrogel formation after photocrosslinking (FIG. 26). TA HR-30 w/photo-accessory, 20 mm parallel plate, 200 μm gap, 1 Hz, 0.1% strain, 10 wt. % solids in water, 2.5 wt. % LAP.
Vat photopolymerization affords high resolution gyroidal lattice (FIG. 27). Asiga Max X27 with 21 mW/cm² UV intensity, 50 μm layer thickness, Burnin cure time 2 s, Std cure time 5 s.

### Example 4

### Non-Limiting Characterization and Performance Data

DLS data confirmed optimal particle size for dispersion and a highly negative zeta potential value indicating solution stability. Photorheology confirms rapid crossover and storage modulus high enough thus forming a robust hydrogel after crosslinking. TGA exhibited thermal stability similar to water soluble polyimide precursors. Rheology indicates low viscosity value indicating potential to increase solids loading and thus minimizing shrinkage after post-processing. Viscosity values at the same solids loading for water soluble polyimide precursor is orders of magnitude greater than that observed from water dispersible polyimide. Vat photopolymerization exhibited printability of high resolution complex 3D architecture.

### Non-Limiting, Exemplary Dispersion Protocol

Varying BDSA-Na loading varies the solubility of polyimide precursor in water. Reducing BDSA-Na loading below 50 mol % allows water dispersibility. To obtain optimal particle size, an emulsifier is used at 10k rpm for 10 mins followed by using a tip sonicator to disperse the particles in water. Surfactant is added to stabilize the latex dispersion along with a water soluble photoiniator. PEGDA 575 is added as crosslinker to obtain optimal storage modulus. Once all components are added, the solution is sonicated for another 2 mins with 30 s on and 10 s off to allow mixing of components and uniform dispersion of the particles. The dispersion stability and particle size are measured using DLS to confirm reproducibility. Dispersing polyimide in water allows potential to vary morphology and allow control over thermal and mechanical performance. Dispersing polyimide also allows pathway for porous 3D carbon structures optimal for infiltration with nanoparticles etc.

### Non-Limiting Methods and Applications

Macrovoids are controlled through the CAD process. Microvoids are introduced through the selection of post-processing. If we desire a dense (micro) carbon structure, we print, air dry, and then dry in vacuo before subjecting to the thermal post-process. If we desire a microporous structure, we print, freeze (OC for 18 h), place in a glass vacuum chamber, submerge in LN2 for 30 min, then reduce pressure to ~100 mtorr for 18 h—this is commonly referred to as “freeze-casting”. There are relationships between freezing protocol and resulting ice structure, which provides further control over pore size and allows for development of higher order pores, like channels.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed is:

1. A polymer comprising an aromatic poly(amic acid) mainchain of the formula: 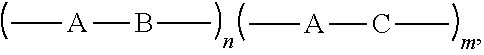
wherein A is an amic acid;
B is an aromatic diamine comprising at least one anionic moiety; and
C is an aromatic diamine.

2. The polymer of claim 1, wherein the amic acid is 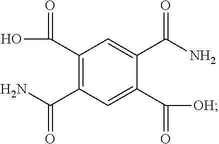 [SMILES: NC(=O)c1cc(C(=O)O)c(C(N)=O)cc1C(=O)O]
wherein the aromatic diamine comprising at least one anionic moiety is selected from the group consisting of: 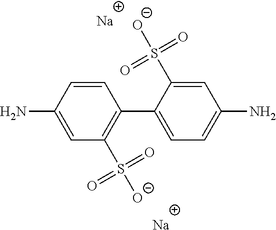 [SMILES: [Na+] ; Nc1ccc(-c2ccc(N)cc2S(=O)(=O)[O-])c(S(=O)(=O)[O-])c1 ; [Na+]]
biphenyl disulfonic acid sodium salt (BDSA-Na) or a derivative thereof; 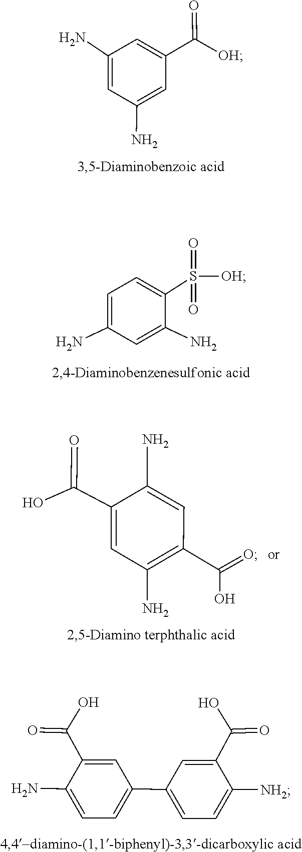 [SMILES: Nc1cc(N)cc(C(=O)O)c1 ; Nc1ccc(S(=O)(=O)O)c(N)c1 ; Nc1cc(C(=O)O)c(N)cc1C(=O)O ; Nc1ccc(-c2ccc(N)c(C(=O)O)c2)cc1C(=O)O]
and
wherein the aromatic diamine is:

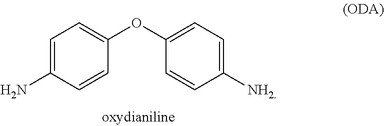 [SMILES: Nc1ccc(Oc2ccc(N)cc2)cc1]

3. The polymer of claim 1, wherein the polymer is: 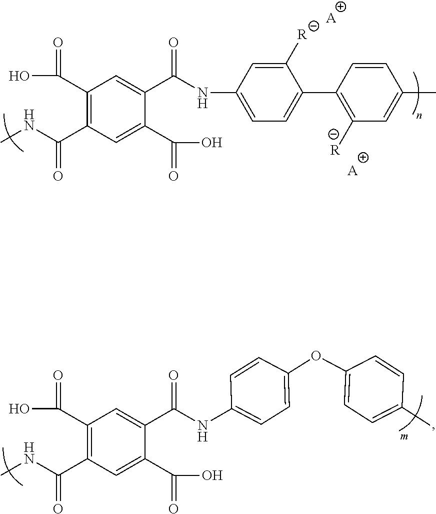
wherein R is selected from the group consisting of a sulfonate, a carboxylate, or a phosphinate;
A is selected from the group consisting of Na⁺, K⁺, ammonium, or Cs⁺; and
n+m=1.

4. The polymer of claim 3, wherein the polymer is:

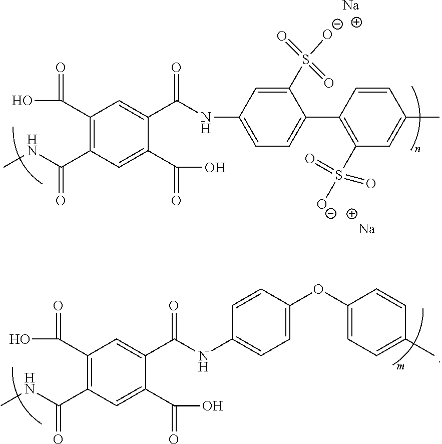

5. The polymer of claim 1, wherein n is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

6. The polymer of claim 1, wherein the polymer is a poly(amic acid) salt comprising the poly(amic acid) mainchain ionically bound to a basic agent, of the following formula: 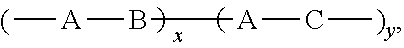
wherein the amic acid is: 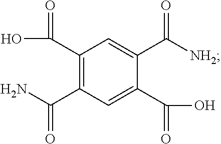 [SMILES: NC(=O)c1cc(C(=O)O)c(C(N)=O)cc1C(=O)O]
wherein the aromatic diamine comprising at least one anionic moiety is selected from the group on consisting of: 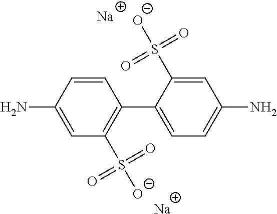 [SMILES: [Na+] ; Nc1ccc(-c2ccc(N)cc2S(=O)(=O)[O-])c(S(=O)(=O)[O-])c1 ; [Na+]]
biphenyl disulfonic acid sodium salt (BDSA-Na) or a derivative thereof; 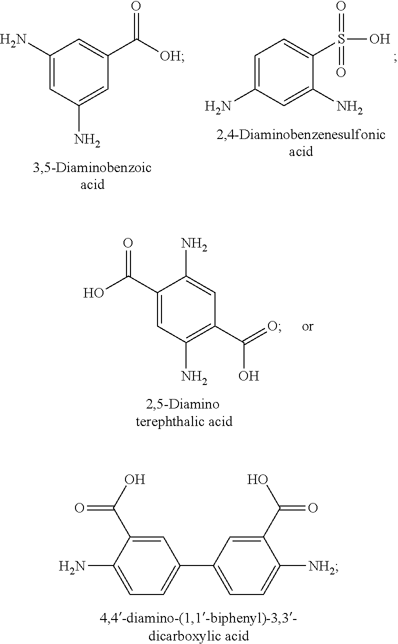 [SMILES: Nc1cc(N)cc(C(=O)O)c1 ; Nc1ccc(S(=O)(=O)O)c(N)c1 ; Nc1cc(C(=O)O)c(N)cc1C(=O)O ; Nc1ccc(-c2ccc(N)c(C(=O)O)c2)cc1C(=O)O]
and
wherein the aromatic diamine is

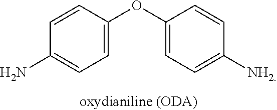 [SMILES: Nc1ccc(Oc2ccc(N)cc2)cc1]

7. The polymer of claim 6, wherein the poly(amic acid) salt is 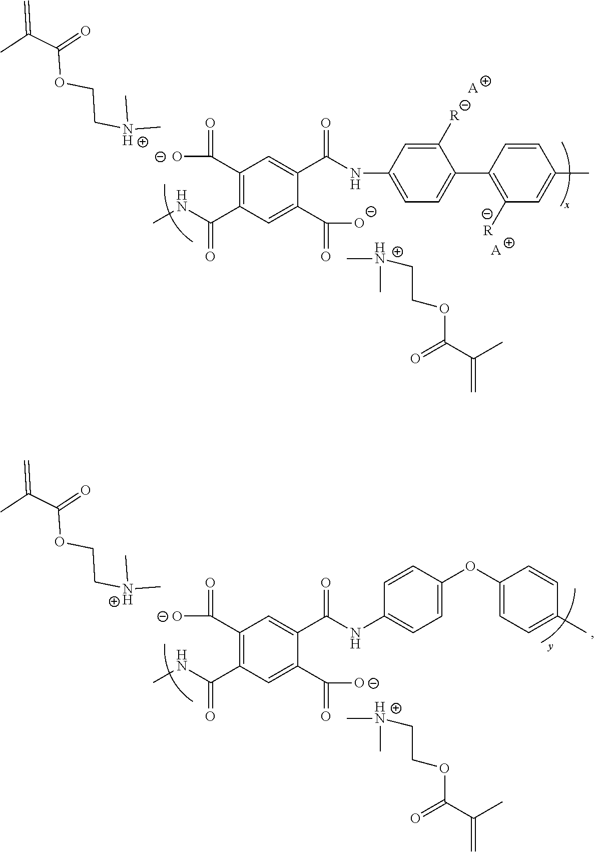
wherein R is selected from the group consisting of a sulfonate, a carboxylate, or a phosphinate;
A is selected from the group consisting of Na⁺, K⁺, or Cs⁺; and
x+y=1.

8. The polymer of claim 6, wherein x is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

9. (canceled)

10. The polymer of claim 6, wherein the basic agent is selected from the group consisting of:

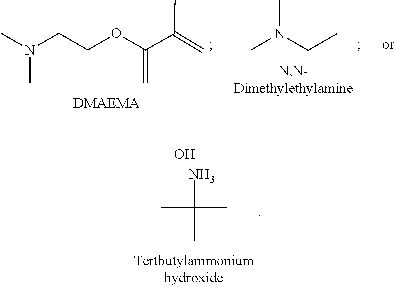

11. The polymer of claim 6, wherein the poly(amic acid) salt is:

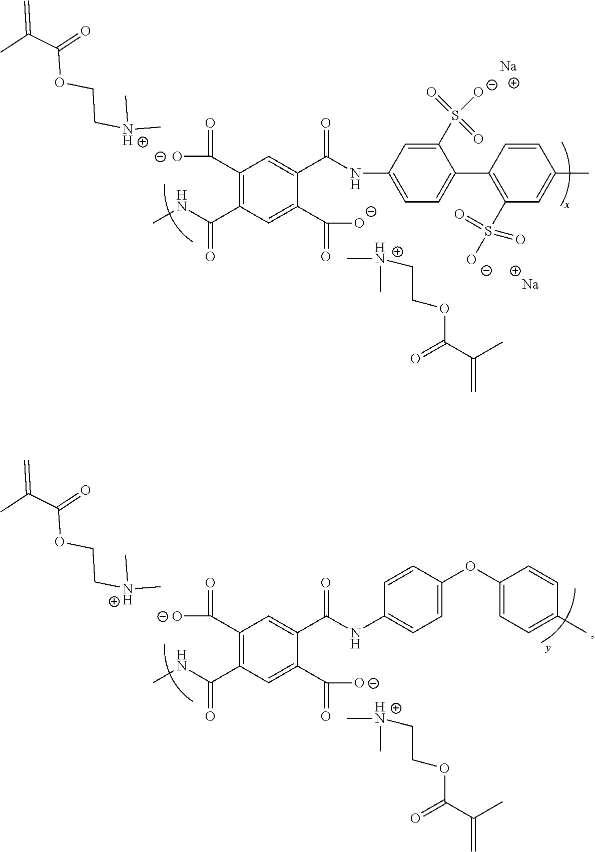

12. A polyimide produced from imidization of the poly(amic acid) salt of claim 6.

13. The polyimide of claim 12, wherein the polyimide is:

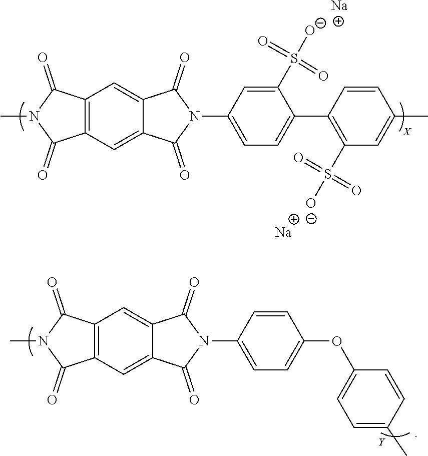

14. A method of producing a poly(amic acid) salt, the method comprising:
copolymerizing an aromatic dianhydride with at least two aromatic amines, wherein at least one aromatic amine comprises at least one anionic moiety, thereby producing an aromatic poly(amic acid); and
adding a basic agent to neutralize the poly(amic acid), thereby producing a poly(amic acid) salt.

15. The method of claim 14, wherein the aromatic dianhydride comprises pyromellitic dianhydride (PMDA).

16. The method of claim 14, wherein the at least two aromatic amines comprise oxydianiline (ODA) and biphenyl disulfonic acid sodium salt (BDSA-Na).

17. The method of claim 14, wherein the poly(amic acid) is: 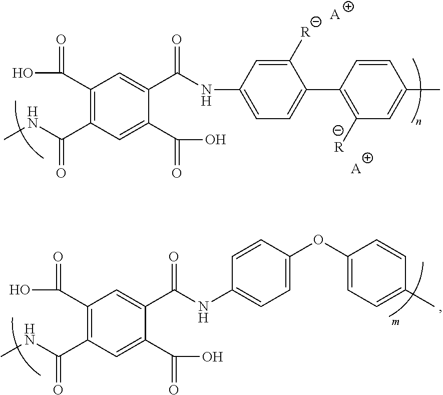
wherein R is selected from the group consisting of a sulfonate, a carboxylate, or a phosphinate;
A is selected from the group consisting of Na⁺, K⁺, or Cs⁺;
n+m=1; and
n is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

18. The method of claim 17, wherein the poly(amic acid) is:

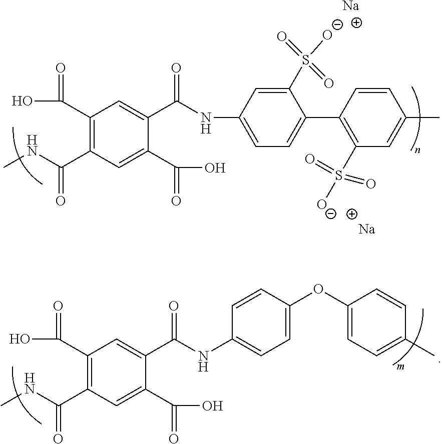

19. The method of claim 14, wherein the basic agent comprises an amino-functionalized methacrylate.

20. The method of claim 14, wherein the basic agent is selected from the group consisting of:

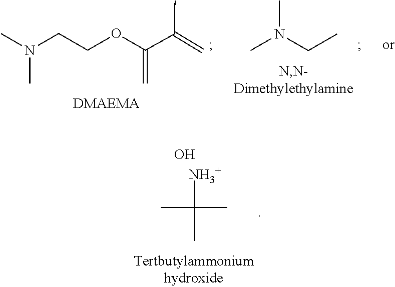

21. The method of claim 14, wherein the poly(amic acid) salt is: 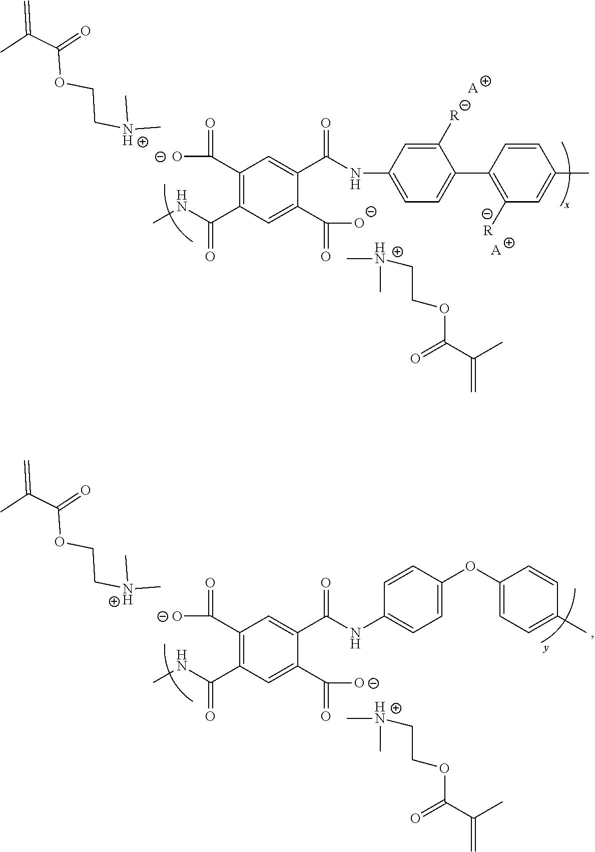
wherein R is selected from the group consisting of a sulfonate, a carboxylate, or a phosphinate;
A is selected from the group consisting of Na⁺, K⁺, or Cs⁺;
x+y=1; and
x is selected from the group consisting of about 0.05, about 0.0.075, about 0.1, about 0.125, about 0.15, about 0.175, about 0.20, about 0.225, about 0.25, about 0.275, about 0.30, about 0.325, about 0.35, about 0.375, about 0.40, about 0.425, about 0.45, about 0.475, about 0.50, about 0.525, about 0.55, about 0.575, about 0.60, about 0.625, about 0.65, about 0.675, about 0.70, about 0.725, about 0.75, about 0.775, about 0.80, about 0.825, about 0.850, about 0.875, about 0.90, about 0.925, about 0.95, or about 1.0.

22. The method of claim 21, wherein the poly(amic acid) salt is:

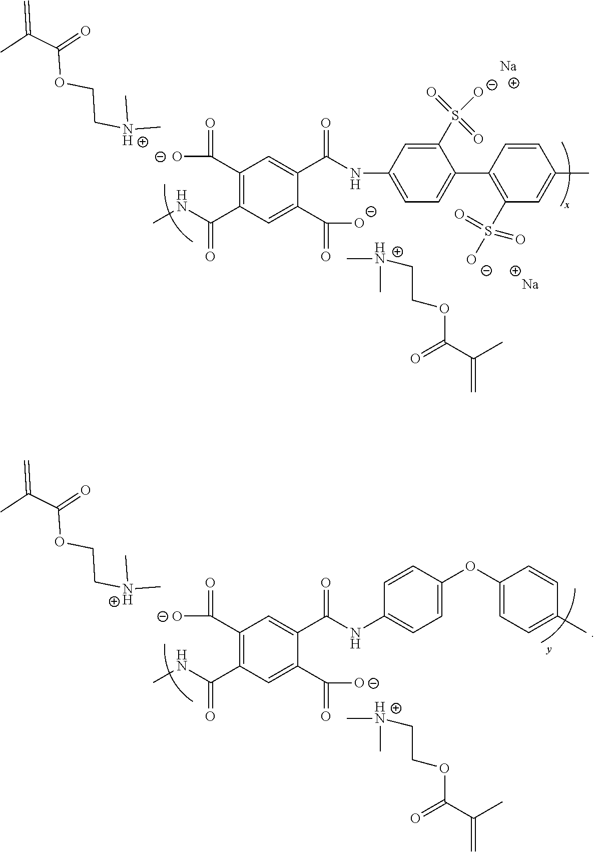

23.-37. (canceled)
